(19) United States
(12) Patent Application Publication
(10) Pub. No.: US 2011/0178819 A1
(43) Pub. Date: Jul. 21, 2011

(54) DEVICES AND METHODS FOR DETERMINING A PATIENT'S PROPENSITY TO ADHERE TO A MEDICATION PRESCRIPTION

(75) Inventor: Colleen A. Mchorney, North Wales, PA (US)

(73) Assignee: MERCK SHARP & DOHME CORP., Rahway, NJ (US)

(21) Appl. No.: 13/121,925

(22) PCT Filed: Oct. 5, 2009
(86) PCT No.: PCT/US2009/059556

§ 371 Date: Mar. 30, 2011

Related U.S. Application Data
(60) Provisional application No. 61/102,957, filed on Oct. 6, 2008.

(51) Int. Cl. G06Q 50/00

(52) U.S. Cl. 705/2

(57) ABSTRACT

Devices and methods for determining risk groups for patients according to their propensity to adhere to a medication prescription The “Adherence Estimator™” device of the present invention comprises an incremented scale of potential total scores, a prescription survey having questions directed to assessing a patient's beliefs in respect to no more than three domains, the three domains being commitment, concerns and cost, a response recording tool, a scoring matrix and an interpretation tool Embodiments of the invention, which may be implemented in electronic or non-electronic forms, automatically score and interpret responses to the prescription survey questions in order to determine and assign patients to a high risk group, a medium risk group or a low risk group Non-electronic devices of the invention may be constructed from a variety of materials, including without limitation, paper, paper-based products, plastic, wood or metal.

### TECHNICAL FIELD

The present invention relates to devices and methods for segmenting patients according to their estimated propensities to adhere to a medication prescription.

### BACKGROUND ART

Adherence to prescription medications has been labeled as our “other drug problem,” an “epidemic,” and a “worldwide problem of striking magnitude.” Research across forty years has documented that adherence to prescription medications, regardless of diagnosis, is poor. Up to 20% of patients do not fill a new prescription. Of those who do fill, approximately one half discontinue therapy in the first six months.

Regardless of disease, non-adherence yields missed opportunities for patients, health care providers, payers and employers, pharmacies, and pharmaceutical companies. Non-adherence thwarts the ability of patients to reach their clinical goals and can result in disease progression, untoward clinical sequelae, and suboptimal patient outcomes. For providers, non-adherence yields frustration in clinical management and can result in economic loss for those reimbursed under pay-for-performance. Non-adherence increases health care costs for payers and employers and contributes to suboptimal beneficiary outcomes. For pharmaceutical companies who discover and manufacture prescription medications, and pharmacies who sell them, non-adherence results in significant revenue loss.

Since the early 1960's, over 32,000 articles have been published on adherence to prescription medications. Much of this work has been descriptive in nature, documenting the extent of non-adherence across disease and demographic groups. There has also been a profusion of instruments that measure adherence barriers and facilitators. Constructs in these instruments include, but are not limited to, medication beliefs, medication concerns, perceived barriers to medication taking, perceived medication benefits, perceived need for medications, experience or fear of side effects, perceived medication efficacy, regimen intrusiveness, adherence self-efficacy, and aversion to medications. A host of other instruments measure adherence per se and are generic as well as disease specific in content. The National Council on Patient Information and Education, a coalition whose mission is to improve communication of information on medications to consumers and healthcare professionals, has advocated routine screening for non-adherence in clinical practice. Other clinical leaders have echoed this recommendation.

Several surveys have been developed to screen for non-adherence in specific diseases and/or specialties—three for psychotic disorders, four for antiretroviral therapy, two for antihypertensive therapy, one for rheumatologic disorders, and one for pediatric disorders. Only four tools have been developed to screen for non-adherence across a wide array of chronic diseases—the Brief Medication Questionnaire, the Stages of Change for Medication Adherence, the Beliefs and Behavior Questionnaire (BBQ), and the ASK-20 Survey. The length of the BBQ (30 items), the ASK-20 (20 items), and the Brief Medication Questionnaire (minimum of 17 items) renders them less practical for use in clinical practice. The ASK-20, which was not based on any theoretical foundation, was just published in June 2008, and there is no experience with the survey outside of its developers. The Brief Medication Questionnaire has not enjoyed widespread use in clinical practice or research. The two-item Stages of Change for Medication Adherence, based on the transtheoretical model, poorly predicted subsequent adherence to antiretroviral therapy. Further, it is uncertain how relevant the theoretical underpinnings of the transtheoretical model are for adherence to prescription medications versus health behavior change, such as smoking cessation and mammography adoption.

Given the magnitude of the non-adherence problem, the fact that it equally affects all diagnostic and demographic groups, and the significant economic and clinical tolls that it engenders, what is needed is a brief, generic screening tool that provides an estimate of the likelihood of non-adherence on an individual-patient basis. Such a tool could make a palpable contribution to clinical practice and to population health. This tool would be even more valuable if it were easy to integrate into the ecosystem of a typical medical office.

### DISCLOSURE OF INVENTION

The present invention addresses the above-described problems and needs by providing devices and methods for grouping patients according to their propensity to adhere to a medication prescription. One aspect of the invention provides an easy-to-use device, referred to hereinafter as “The Adherence Estimator™,” for determining a risk group for a patient, comprising an incremented scale of potential total scores, a prescription survey, a response recording tool, a scoring matrix and an interpretation tool. In a preferred embodiment, patients are grouped according to a patient classification system comprising three groups (or “categories”), including a high risk group, a medium risk group and a low risk group. The high risk group describes patients having a greater risk for non-adherence relative to patients in the low risk group and the medium risk group. The low risk group describes patients having a lesser risk of non-adherence relative to patients in the medium risk group and the high risk group. The medium risk group describes patients having a risk for non-adherence that falls between the greater risk and the lesser risk groups. It will be appreciated by those skilled in that art that a different patient classification system, which uses different names for the risk groups or a different number of risks groups, could also be used without departing from the scope of the invention.

The incremented scale of potential total scores has a first range of potential total scores corresponding to the high risk group, a second range of potential total scores corresponding to the medium risk group, and a third range of potential total scores corresponding to the low risk group. The incremented scale of potential total scores correlates actual scores to the different risk groups.

The prescription survey comprises a plurality of questions to assess the patient's beliefs in respect to no more than three domains, the three domains being (i) the patient's perceived need for the prescription medication, (ii) the patient's perceived safety concerns about the prescription medication, and (iii) the patient's perceived affordability for the prescription medication. These three domains may sometimes be referred to as the commitment domain, the concern domain and the cost (or affordability) domain.

The response recording tool is configured to present for each question in the plurality of questions a plurality of potential patient responses, and to record for the plurality of questions a set of actual patient responses given by the patient.

The scoring matrix is configured to correlate the plurality of potential patient responses for each question in the survey to a plurality of partial scores, respectively. Notably, the plurality of partial scores are selected and arranged in the scoring matrix so that there can be only one set of actual patient responses having correlated partial scores that, when summed together, produces an actual total score equal to a given potential total score on the incremented scale.

And finally, the interpretation tool indicates that the patient should be assigned to the high risk group if the actual total score is equivalent to a potential total score that falls within the first range on the incremented scale, indicates that the patient should be assigned to the medium risk group if the actual total score is equivalent to a potential total score that falls within the second range on the incremented scale, and indicates that the patient should be assigned to the low risk group if the actual total score is equivalent to a potential total score that falls within the third range on the incremented scale.

In some embodiments, the plurality of questions to assess the patient's beliefs in respect to the three domains may comprise no more than a single question for each one of the three domains. For instance, the single question to assess the patient's beliefs in respect to the domain of the patient's perceived need for the prescription medication (the commitment domain) may prompt the patient to disclose the extent to which the patient is convinced of the importance of the prescription medication. The single question to assess the patient's beliefs in respect to the domain of the patient's perceived safety concerns about the prescription medication (a.k.a., the concern domain) may prompt the patient to disclose the extent to which the patient worries that the prescription medication will do more harm than good. And the single question to assess the patient's beliefs in respect to the domain of the patient's perceived affordability for the prescription medication (a.k.a. the cost domain) may prompt the patient to disclose the extent to which the patient feels financially burdened by an expense associated with taking the prescription medication. In other embodiments, the plurality of questions to assess the patient's beliefs in respect to the three domains may comprise multiplicity of questions for each one of the three domains.

In still other embodiments, the prescription survey may focus on no more than two domains, the two domains being (i) the patient's perceived need for the prescription medication (commitment domain), and (ii) the patient's perceived safety concerns about the prescription medication (concerns domain). Such embodiments are particularly useful in situations where prescription medication cost may not be a significant factor in prescription medication adherence, because, for example, the medication costs are subsidized or reimbursed by a governmental entity or insurance agent.

Embodiments of the invention may be implemented in both electronic and non- electronic forms. Non-electronic devices of the invention may be constructed from a variety of materials, including without limitation, paper, paper-based products, plastic, wood or metal. Electronically-implemented versions of the invention may be embodied in preprogrammed computer systems and/or interconnected computer networks adapted for interactive use by patients and/or medical professionals.

In the non-electronic versions, for instance, the survey questions may be presented to the user in written form on printed cards or sheets of paper, which printed cards or sheets of paper may also include the plurality of potential patient responses, as well as mechanisms for recording the set of actual patient responses received from the patient in response to the survey questions (e.g., an arrangement of spaces or checkboxes that can be marked for selection by the patient). The scoring matrix, which may be embodied on the same or a separate card or sheet of paper, may include a plurality of “see-through” windows or voids that, when properly positioned in relation to the response recording tool, permit the set of actual patient responses on the response recording component to be seen through the windows or voids. Each one of the plurality of partial scores in the scoring matrix may be printed or indicated in spaces adjacent to each one of the plurality of windows or voids. This arrangement of the response recording tool and scoring matrix permits the user to associate every actual patient response for every survey question with a partial score from the scoring matrix. The partial scores may then be manually or automatically summed together in order to produce an actual total score, which is then compared to the potential total scores on the incremented scale to determine, based on the scale and the patient classification system, which risk group to assign to the patient.

An electronically-implemented Adherence Estimator™ configured to operate according to the present invention may be implemented on a computer system comprising a plurality of software and hardware components arranged and preprogrammed to read or display the survey to the patient on a computer-controlled display device and to receive the patient's responses via one or more associated human interface devices, such as keyboards, mice, touch screen video displays, keypads or voice recognition devices. The components include computer-readable machine instructions that, when read by a processor, cause the processor to store, score, and interpret the patient responses and generate output indicating to the patient (or an operator) whether the patient falls into a high risk, medium risk, or low risk group of patients in terms of the patient's propensity to adhere. The computer system may also be configured to produce a unique message or instruction based on the identified risk group and send the unique message to a variety of interested parties via a plurality of different channels.

A computer system for determining a risk group for a patient based on the patient's propensity to adhere to a prescription medication, according to the invention, comprises a database, a client application, an incremented scale, a rules engine, and a preprogrammed results processor. The database comprises a prescription survey having a plurality of questions to assess the patient's beliefs in respect to no more than three domains, the three domains being (i) the patient's perceived need for the prescription medication, (ii) the patient's perceived safety concerns about the prescription medication, and (iii) the patient's perceived affordability for the prescription medication.

The client application is configured to display (or otherwise present) the plurality of questions and a respective plurality of potential patient responses for each one of said plurality of questions, and to receive (from the patient or another end user) a set of actual patient responses. The rules engine comprises one or more data structures defining an incremented scale of potential total scores having a first range of potential total scores corresponding to a high risk group, a second range of potential total scores corresponding to a medium risk group, and a third range of potential total scores corresponding to a low risk group.

The rules engine also defines a scoring matrix configured to correlate the plurality of potential patient responses for said each question to a plurality of partial scores, respectively, wherein the plurality of partial scores are selected and arranged in the scoring matrix so that there can be only one set of actual patient responses having correlated partial scores that, when summed together, produces an actual total score equal to a given potential total score on the incremented scale.

The preprogrammed results processor automatically assigns the patient to the high risk group if the actual total score is equivalent to a potential total score that falls within the first range on the incremented scale, automatically assigns the patient to the medium risk group if the actual total score is equivalent to a potential total score that falls within the second range on the incremented scale, and automatically assigns the patient to the low risk group if the actual total score is equivalent to a potential total score that falls within the third range on the incremented scale.

An electronically-implemented version of an Adherence Estimator™ of the present invention may also be implemented in network of computer systems comprising a client device, a server computer coupled to the client device via an interconnected data communications network. The client device includes a web browser or installed application configured to display to an end user a user interface screen comprising a plurality of survey questions and corresponding response input fields. In some cases, the client device may be configured to play or “speak” audibly-recorded survey questions to the end user via a speaker or other sound-producing device. Each of the survey questions has six possible responses, of which one and only one response is permitted per question. Each of the six responses is uniquely weighted per question. The patient's responses to the survey questions are received from the patient via the user interfaced screen (or via keypad entry or voice-recognition technology) and then sent to the server, where a preprogrammed results processor correlates them to a plurality of partial scores defined by a scoring matrix embodied in a rules engine. The preprogrammed results processor sums the partial scores together to produce an actual total score, and automatically interprets the actual total score by comparing them to a stored incremented scale of potential total scores. Based on the comparison, the preprogrammed results processor produces an estimate of the patient's risk of non-adherence (low/medium/high). In some embodiments, the preprogrammed results processor may send a unique message back to the client device, which sends that unique message to the patient and/or end user by some method, such as display it on a display device, printing it on a printer, or playing it on a speaker, for example. The user interface screen may be implemented, for example, by utilizing a hypertext markup language (“html”) form or a macromedia flash interactive input form, both of which may be programmed to display on the end user's monitor according to methods and techniques well-known in the computer arts.

The client device includes a client application logic processor, which executes within the web browser or installed application, and which is configured to capture data (patients' responses to survey questions) entered into each one of the plurality of data input fields by the end user. Based on the responses, the client application logic processor generates a request to produce partial and total scores for the responses and to produce a risk estimate and an appropriate message from the message database that is based on the total score. The client device further includes a client communications interface configured to transmit the request and the patient's responses to the survey questions to the server computer via the interconnected data communications network.

As will be described in more detail below, the server computer receives the request and the patient responses from the client device via the interconnected data communications network, stores the responses in the server database, produces an actual total score and a risk assessment (high, medium or low risk) based on the responses, sends the risk assessment and an appropriate message back to the client device and/or triggers a delivery of the assessment and the message via a plurality of distribution channels. When the risk assessment and the message are received by the client device, the client application logic processor displays the assessment and the message on a user interface screen (or otherwise presents the assessment and message to the user by some other means, such as playing a recorded message, thereby providing the end user with valuable information to address their medication adherence issues. In addition, based on the configuration of the system, the end user may also receive the message in an email, text message, via phone, direct mail, etc.

In another aspect of the invention, there is provided a method for determining a risk group for a patient according to the patient's propensity to adhere to a prescription medication using an interconnected computer network comprising a client device, a server, a preprogrammed results processor, a rules engine and at least one data storage area. The method comprises the steps of:

a) storing in the data storage area an incremented scale of potential total scores having a first range of potential total scores corresponding to a high risk group, a second range of potential total scores corresponding to a medium risk group, and a third range of potential total scores corresponding to a low risk group;

b) storing in the data storage area a prescription survey comprising a plurality of questions to assess the patient's beliefs in respect to no more than three domains, the three domains being (i) the patient's perceived need for the prescription medication, (ii) the patient's perceived safety concerns about the prescription medication, and (iii) the patient's perceived affordability for the prescription medication;

c) preconfiguring the rules engine to define a scoring matrix that correlates a plurality of potential patient responses for each question to a plurality of partial scores, respectively, wherein the plurality of partial scores are selected and arranged in the scoring matrix so that there can be only one set of actual patient responses that have correlated partial scores that, when summed together, produces an actual total score equal to a given potential total score on the incremented scale;

d) presenting the plurality of questions and the plurality of potential patient responses on the client device;

e) recording in the data storage area a set of actual patient responses entered into the client device by the patient in response to said plurality of questions;

f) causing the preprogrammed results processor to automatically produce an actual total score for the patient, in accordance with the rules engine and the scoring matrix, by summing together the partial scores correlated to the set of actual patient responses given by the patient; and

g) causing the preprogrammed results processor to assign the patient to a risk group, wherein the preprogrammed computer processor will (i) automatically assign the patient to the high risk group if the actual total score is equivalent to a potential total score within the first range on the incremented scale, (ii) automatically assign the patient to the medium risk group if the actual total score is equivalent to a potential total score within the second range on the incremented scale, and (iii) automatically assign the patient to the low risk group if the actual total score is equivalent to a potential total score within the third range on the incremented scale.

In yet another aspect of the present invention, there is provided a method for scoring and interpreting survey responses to determine the propensity of a patient to adhere to a new medication prescription using an interconnected data communications network, the method comprising the steps of: (1) using a web browser or installed application to present to an end user (such as a patient) a user interface screen comprising a plurality of survey questions and response input fields; (2) capturing data entered into each one of the plurality of response input fields by the end user; (3) generating a request to score and interpret the survey response; (4) transmitting the request and the patient responses to the server computer via the interconnected data communications network; (5) storing the survey responses; (6) correlating the responses to partial scores; (7) generating a risk assessment (high, medium, low) based on the responses; (8) transmitting the assessment to the client computer; and (9) displaying a message on the user interface screen presented by the web browser or installed application and/or triggering the delivery of the message in a plurality of channels.

A variety of different types of applications may benefit by application of the present invention, including without limitation, custom integration services and/or third party plug-ins to Electronic Medical Record (EMR) system, which is a specialized database management system used in physician's offices to capture, store, and report on patient's medical records.

Embodiments of the present invention permit scalability in that a plurality of questions and responses can be stored in and retrieved from a question and response database. In addition, a plurality of surveys comprising the questions and responses can be stored in and retrieved from a survey database, and a plurality of messages can be stored in and retrieved from a message database.

A more complete understanding of the invention will be made apparent from the following detailed description of various embodiments of the invention in connection with the accompanying drawings and appended claims.

### BRIEF DESCRIPTION OF THE DRAWINGS

The accompanying drawings, which are incorporated into and constitute part of the specification, illustrate embodiments of the present invention, and, together with the description, serve to explain some of its features.

FIG. 1 shows an example of a printed card incorporating a prescription survey and a response recording tool of a non-electronic paper or paper-based version of the present invention.

FIG. 2 shows an example of a printed card incorporating an interpretation tool for a paper or paper-based version of the present invention, wherein the interpretation tool includes the scoring matrix and the incremented scale of potential total scores.

FIGS. 3 and 4 show, by way of example, how the exemplary printed cards of FIGS. 1 and 2 may be combined, according to some embodiments of the invention, such that the set of actual patient responses to the survey questions can be viewed and correlated to the partial scores in the scoring matrix.

FIG. 5 depicts an exemplary user interface screen, suitable for use with an electronically-implemented embodiment of the present invention, for presenting the prescription survey.

FIG. 6 shows a block diagram illustrating an exemplary embodiment of a computer network for carrying out the invention in an application service provider (ASP) environment.

FIG. 7 shows a block diagram illustrating an exemplary embodiment of a computer network for carrying out the invention in a client-server environment.

FIG. 8 shows a program flow diagram illustrating the steps that may be performed by a server computer system configured to operate according to an exemplary embodiment of the present invention.

FIGS. 9 and 10 show high-level block diagrams of alternative standalone electronic embodiments of the invention, wherein all of the components are associated with the computer system comprising the client device.

### OVERVIEW OF METHODS USED TO DETERMINE DOMAINS AND SELECT PARTIAL SCORES FOR THE SCORING MATRIX

There are many ways to measure adherence including: (1) self-report; (2) pharmacy refill claims; (3) pill counts; (4) electronic drug monitoring; (5) biochemical markers; and (6) directly-observed therapy. Each way of assessing adherence has its own unique advantages and disadvantages, and none are perfect. The inventor of the present invention chose to use self-reported adherence as the indicator of adherence. As the indicator of adherence, it is the dependent variable—meaning it is the outcome the inventor wished to predict.

As will be described in more detail below, two waves of psychometric testing were conducted using the Harris Chronic Disease Panel. From the first wave, it was determined that the three domains of medication concerns, medication affordability, and perceived need for medications best discriminated between adherers and non-adherers to prescription medication (See Table 2, top panel). In the second wave of psychometric testing, a larger, independent sample was used, which reconfirmed that these same three domains—medication concerns, medication affordability, and perceived need for medications—best discriminated between adherers and non-adherers (See Table 4, top panel, and Table 5). The next step in the process was to select the single best item (i.e., question) within each domain to include in the physical embodiments of the present invention. This process in described in more detail below under the subheading “Item Selection For The Adherence Estimator™.”

From the psychometric testing it was deduced that the three selected items for The Adherence Estimator™ differed in their predictive ability to differentiate adherers from non-adherers. Further, within each item, each of the six categorical response categories also differed in their predictive ability to differentiate adherers from non-adherers. Because of these facts, it would be inappropriate to give equal weight to the three items in the scoring matrix, and it would be equally inappropriate to give equal weight to each of the six response categories. Therefore, weights must be assigned to each of the six categorical responses for each question in order to account for the differences in the predictive abilities of the three questions and the six categorical responses. Therefore, the task in deriving the scoring matrix was to determine what weights should be given to each item and what weights should be given to the response categories for each item in order to derive an actual total score for the set of responses provided by a patient using an embodiment of the invention.

To carry out this task, the same logic applied in all of the other psychometric analyses was used. The dependent variable was self-reported adherence among the 1,072 respondents to our Harris Interactive survey. To understand the weights given to each response category for each item/question, it was necessary to decompose the items into their constituent elements. For each of the three items/questions, five variables were created from the six possible responses. For example, the weights for x1, x2, x3, x4, and x5 are relative to the omitted group—x6. All but one of the possible responses is in the model. The single response that is excluded serves as the reference group against which comparisons are made. The goal was to understand how each of the 15 variables predict self-reported adherence. Modeling all of the 15 together allowed for their synergistic effect since they are not completely orthogonal (unrelated) to one another.
Rx affordability: x1=agree completely, x2=agree mostly, x3=agree somewhat, x4=disagree somewhat, x5=disagree mostly. The reference or hold-out group is disagree completely.
Rx concerns: x6=agree completely, x7=agree mostly, x8=agree somewhat, x9=disagree somewhat, x10=disagree mostly. The reference or hold-out group is disagree completely.
Rx conviction: x11=disagree completely, x12=disagree mostly, x13=disagree somewhat, x14=agree somewhat, x15=agree mostly. The reference or hold-out group is agree completely.

Logistic regression was used to estimate the weights associated with each of the 15 variables. A widely-available statistical analysis software (SAS) was used to perform the logistic regression to obtain the scores for each of the 15 variables, which are the scores shown in Table 6 below. Logistic regression is a statistical procedure used to predict an outcome that only has two levels. In this case, the two levels are (0) adherent and (1) non-adherent. Other statistical procedures are not as well suited for predicting two and only two levels as is logistic regression. Although SAS was used, other statistical programs that could be used for this purpose are SPSS and STATA. The logistic regression equation is as follows:

Self-reported adherence (no/yes)=P or probability of adherence

Logit P/1−P=β₀+β₁x₁+β₂x₂+β₃x₃+β₄x₄+β₅x₅+β₆x₆+β₇x₇+β₈x₈+β₉x₉+β₁₀x₁₀+β₁₁x₁₁+β₁₂x₁₂+β₁₃x₁₃+β₁₄x₁₄+β₁₅x₁₅

The logistic regression procedure predicts the probability (or risk) of being non-adherent.

This equation and the logistic regression procedure generated β weights (which were then exponentitated into odds ratios) for each of the 15 variables. The odds ratios derived from the logistic regression procedure (with some minor rounding) were then used as the partial scores shown in Table 6. For example, the “7” in row 1 column 3 of Table 6 indicates that persons who endorse “agree somewhat” to the “I am convinced” question are seven times more likely to be non-adherent compared to those who endorse “agree completely” to the “I am convinced” question. As shown in Table 6, it was determined that the domain “perceived need for medications” is most strongly related to adherence (weights of 20, 20, 7, 7, 0, 0), followed by the domain of “medication concerns” (weights of 14, 14, 4, 4, 0, 0), followed by the domain of “medication affordability” (weights of 2, 2, 0, 0, 0, 0).

When a respondent answers each of the three questions in the survey, they receive a partial score (i.e., weight) for each response to each question. The three partial scores/weights are then summed together to obtain the actual total score. Using Table 6 as a guide, if a patient responds “disagree mostly” to the question “I am convinced of the importance of my medication” (partial score of 20), “agree mostly” to the question “I worry that my prescription will do more harm than good” (partial score of 14), and “agree completely” to “I feel financially burdened by my out-of-pocket expenses for my prescription medication” (partial score of 2), then the patient's actual total score would be 36. Embodiments of the invention would then compare this actual total score of 36 to the potential total scores in the incremented scale, which correlates to the “high risk” group.

### MODES FOR CARRYING OUT THE INVENTION

Reference will now be made in detail to embodiments of the invention, examples of which are illustrated in the accompanying drawings. Notably, non-electronic versions of the present invention may be implemented using paper, paper-based materials, plastic metal or wood, while electronically-implemented versions may be implemented using software, hardware, or any combination thereof, as would be apparent to those of skill in the art, and the figures and examples below are meant clarify without limiting the scope of the present invention or its embodiments or equivalents.

Electronic embodiments of the invention may be implemented on an computer network associated with an interconnected data communications network, such as the Internet, by programming and/or providing distributed hardware and software components for receiving, storing, scoring, and interpreting user responses, from a plurality of questions, and generating an output indicating a predicted risk group based on the score and its interpretation. These embodiments will typically present a user with a web-browser based user interface screen, or an installed application user interface screen (such as an HTML or Visual Basic form) containing a plurality of input fields configured to receive input from the user, the input being related to the three domains tending to drive adherence or non-adherence to a new medication prescription.

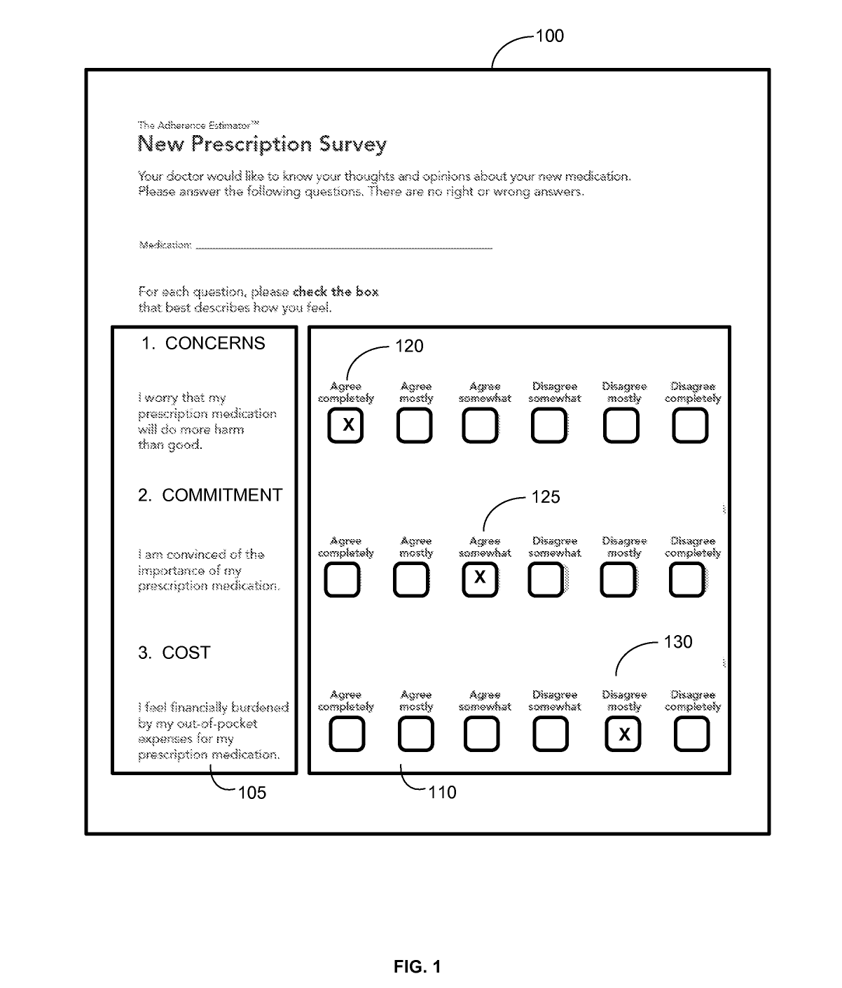

Turning to the drawings, Error! Reference source not found. FIG. 1 shows an example of a printed card 100 incorporating a prescription survey 105 and a response recording tool 110 of a non-electronic paper or paper-based version of the claimed invention. As shown in FIG. 1, the prescription survey 105 comprises a single question for each one of three different domains, the domains being CONCERNS, COMMITMENT and COST. The response recording tool 110 comprises, for each question, six potential responses from which the patient may make a selection by marking or otherwise endorsing a check box located below each potential response. In the example shown in FIG. 1, for instance, the patient has placed an “X,” respectively, in the checkbox below the “Agree completely” potential patient response 120 for the question pertaining to the “CONCERNS” domain, a second “X” in the checkbox below the “Agree somewhat” potential patient response 125 for the question pertaining to the COMMITMENT domain, and a third “X” in the checkbox below the “Disagree mostly” potential patient response 130 for the COST domain. Thus, in this case, the set of actual patient responses for this particular patient has three members, which are potential patient responses 120, 125 and 130.

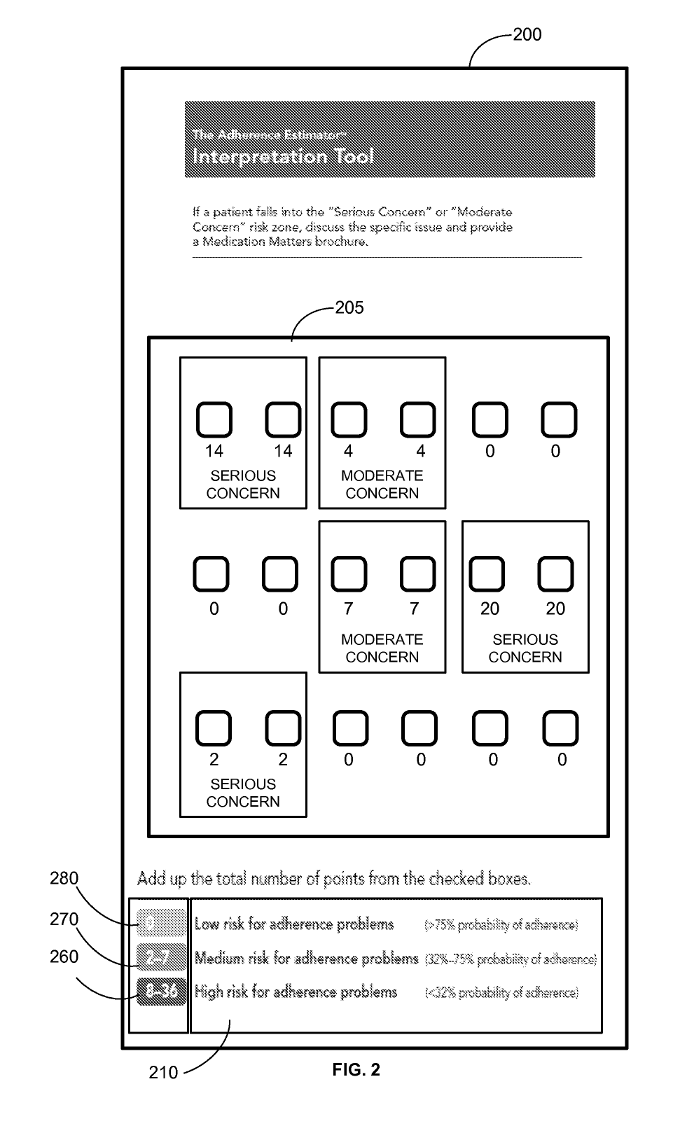

FIG. 2 shows an example of a printed card 200 embodying an interpretation tool, which itself comprises a scoring matrix 205 and an incremented scale of potential total scores 210. Scoring matrix 205 comprises 18 partial scores arranged in a 3-by-6 matrix. In this case, the 18 partial scores are 14, 14, 4, 4, 0, 0, 0, 0, 7, 7, 20, 20, 2, 2, 0, 0, 0 and 0 (reading across and down from the top left corner). Each one of the partial scores in the scoring matrix 205 are printed below one of 18 separate windows, voids or “cut-outs” configured to permit a user to see through the windows, voids or cut-outs. The incremented scale of potential total scores 210 has a first range of values 260 corresponding to a high risk group, a second range of values 270 corresponding to a medium risk group and a third range of values 280 corresponding to a low risk group.

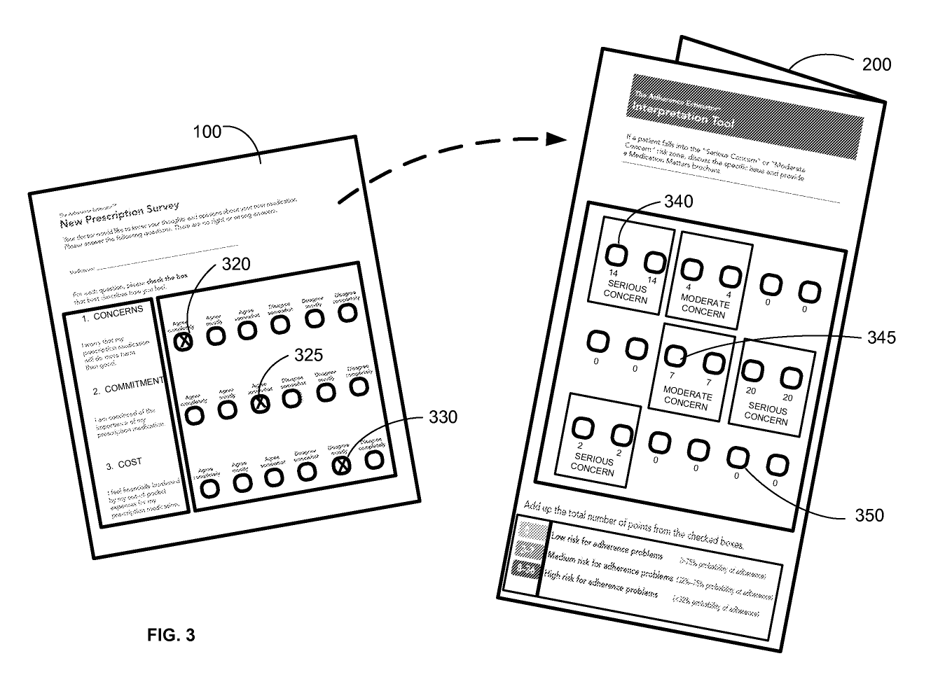

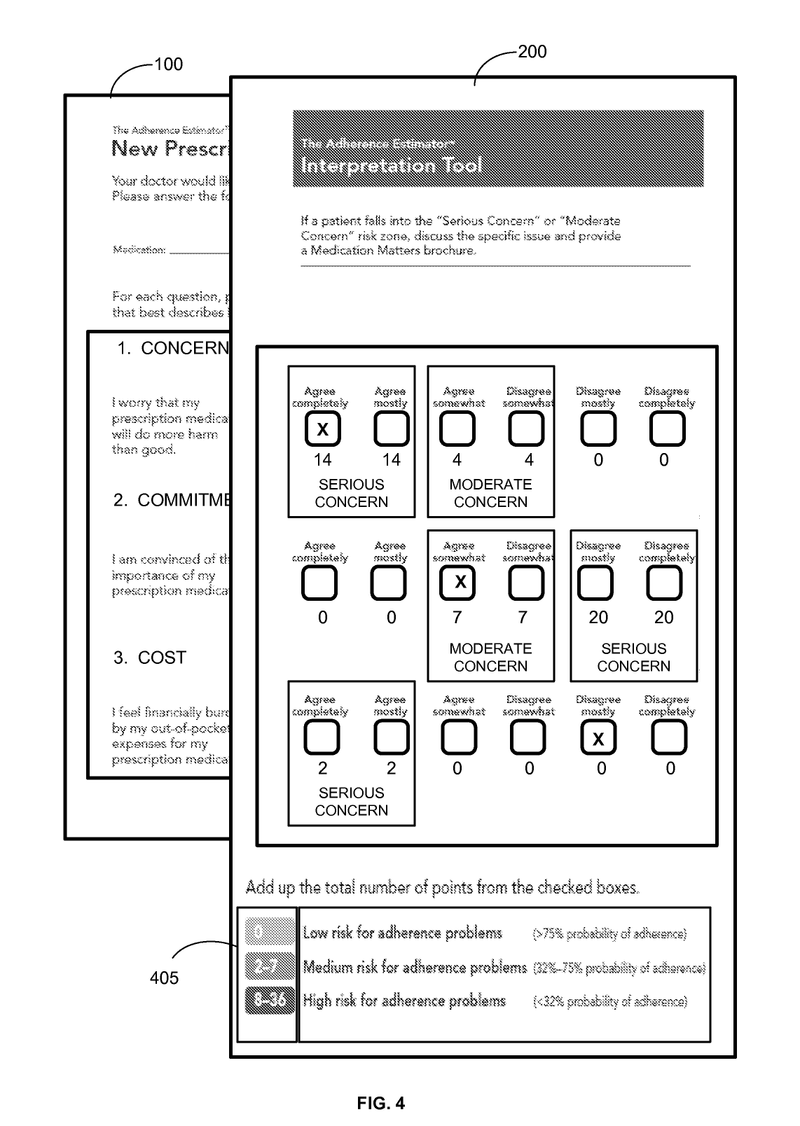

FIG. 3 shows how the exemplary printed card 100 of FIG. 1 may be inserted into or positioned behind the exemplary printed card 200 of FIG. 2, according to some embodiments of the invention, so that the three “X” marks 320, 325 and 330 marking the set of actual patient responses to the survey questions may be aligned with and viewed through the three windows 340, 345 and 350, as shown in FIG. 4. Combining printed cards 100 and 200 in this manner permits the set of actual patient responses received from the patient to be correlated by reference to the scoring matrix 205 with three partial scores having the values of 14, 7 and 0. Summing these three partial scores together produces an actual total score of 21. From the incremented scale 405 shown at the bottom of the interpretation tool of the printed card 200 shown in FIG. 4, it is seen that the actual total score value of 21 corresponds to the high risk group.

The values of the partial scores in the scoring matrix 205 in FIG. 2 are selected and arranged so that the sum of partial scores for each set of actual patient responses will produce a unique actual total score having a value that corresponds to one and only one of the potential total scores on the incremented scale. Thus, for the exemplary embodiment of the invention as depicted in FIGS. 1-4, one and only one set of actual patient responses will have partial scores that, when summed together, equal the value 21. And it would therefore be impossible, because of the selection and arrangement of the partial scores in the scoring matrix 205, to obtain an actual total score of 21 by correlating and adding together the partial scores associated with any other set of actual patient responses. Similarly, every other set of correlated and summed partial scores for any other set of actual patient responses will necessarily produce its own unique actual total score. It should be appreciated by those skilled in the art after reading this disclosure that a variety of different values for the scoring matrix and incremented scale may be used to implement various embodiments of the invention, so long as the values are selected and arranged so that the sum of partial scores for each set of actual patient responses will produce a unique actual total score having a value that corresponds to one and only one of the potential total scores on the incremented scale.

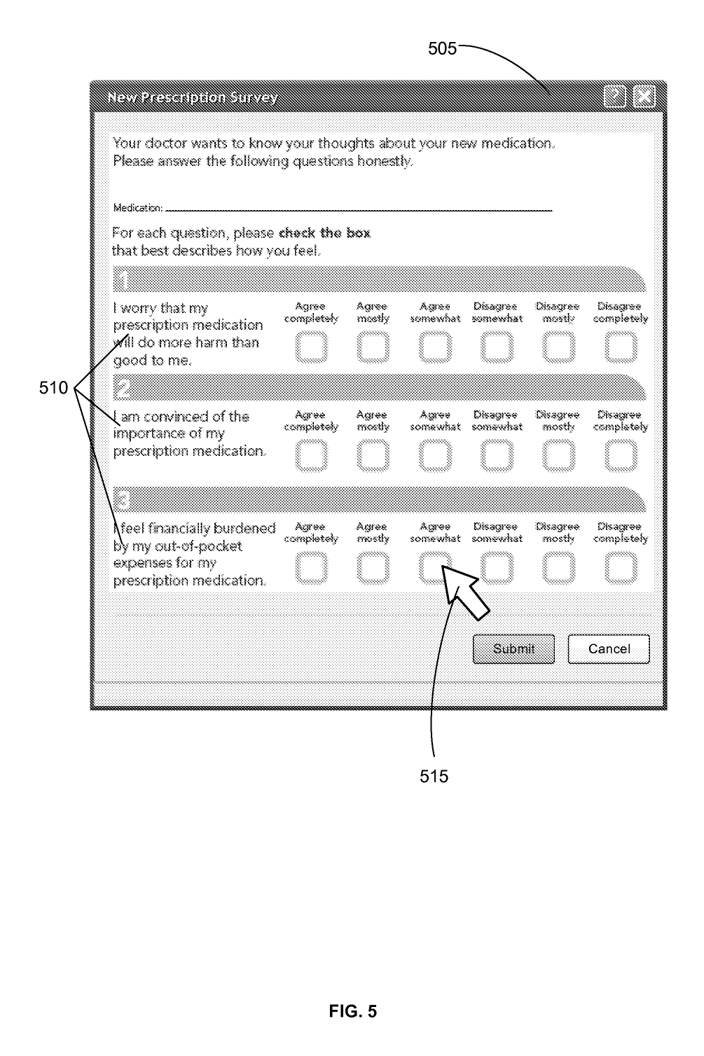

As previously-stated, and as describe in more detail below, embodiments of the invention may be implemented electronically on computer systems and computer networks. FIG. 5 depicts an exemplary user interface screen 505 that might be used in an electronically-implemented embodiment of the present invention to display the prescription survey questions 510 on a computer-controlled display device associated with such a computer system or network. Thus, the patient (or other user) can interact with and submit actual patient responses to the survey questions by manipulating a mouse, keyboard or touch screen display to cause the cursor 515 on the user interface screen 505 to mark and/or transmit the patient's selection of three of the eighteen potential patient responses.

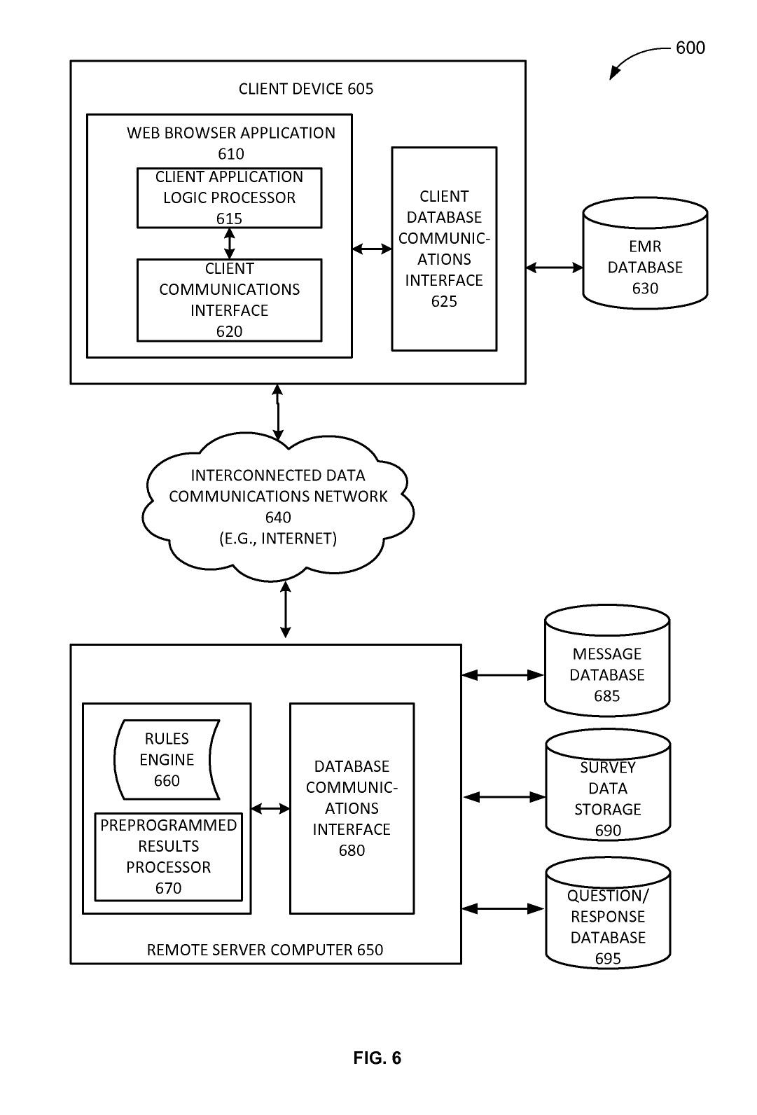

FIG. 6 shows a block diagram of an exemplary hardware and software environment 600 consistent with an embodiment of the invention. As shown in FIG. 6, Client device 605 is coupled to interconnected data communications network 640, which is in turn coupled to remote server computer 650. Remote server computer 650 is also coupled to message database 685, survey data storage 690 and question/response database 695, which typically store a multiplicity of related data records. Interconnected data communications network 640 may comprise, for example, a local area network, a wide area network, a corporate intranet, corporate firewall, and/or the Internet. This network structure represents an application service provider (ASP) model.

Client device 605 usually comprises one of a variety of different types of web-enabled and networked computing devices, including for example, but not limited to, desktop or laptop computers, mini-computers, mainframes, handheld computers, personal digital assistants, mobile cell phones, mobile smart-phones, or tablet PCs having interactive display screens, to name a few examples. Client device 605 is linked to interconnected data communications network 640 via one or more categories of conventional wired or wireless network communications equipment, such as analog, digital subscriber lines (DSL), T1, or cable broadband modems, Ethernet cards and cables, 802.11 wireless cards and routers, and Bluetooth® wireless adaptor cards and links, and the like.

Client device 605 includes a web browser application 610, client application logic processor 615 and client communications interface 620. Preferably, web browser application 610 is programmed in JavaScript and configured to execute within any standard web browser, such as Microsoft Internet Explorer® (MSIE), Netscape®, Firefox®, or Safari®, for example. JavaScript is an interpreted programming or scripting language and which is used in web site development to do such things as creating a drop down list on a web page, automatically changing a formatted date on a web page, causing a linked-to page to appear in a popup window and causing text or graphic images to change during a mouse rollover operation. JavaScript code can be imbedded in hyper text markup language (HTML) pages and interpreted by the web browser (or client). Other interpreted programming or script languages, such as Microsoft's Visual Basic, Sun's Tel, the UNIX-derived Perl, and IBM's Rexx, may also be used to implement web browser application 610, as they are all somewhat similar in function and capacity to JavaScript. In general, script languages are easier and faster to code in than the more structured and compiled languages such as C and C++, or Java, the compiled object-oriented programming language derived from C++. Script languages generally take longer to process than compiled languages, but are very useful for shorter programs.

In this case, Web browser application 610 is programmed to display a user interface screen containing a plurality of survey questions and corresponding response input fields on a display device connected to Client device 605. Each of the survey questions has six possible responses of which one and only one response is permitted. One example of a suitable user interface screen, containing the plurality of survey questions and response input fields, is discussed above with reference to FIG. 5.

Client application logic processor 615 is a program, application module or applet, which executes within web browser application 610, and which makes it possible for the end user to interact with the user interface screen presented by web browser application 610. Client application logic processor 615 monitors the user interface screen (and associated input devices, e.g., keyboard and mouse) and captures data (i.e., responses) entered into the plurality of response input fields by the end user, such as by clicking on the appropriate checkbox, for example. Based on the captured data, client application logic processor 615 generates a request to score and interpret the values entered into the plurality of response input fields by the end user. For performance and efficiency considerations, it may be necessary or desirable to configure client application logic processor 615 to generate the request only after the entered and captured data have been validated. In preferred embodiments, the request contains the responses entered by the end user for each question. Client communications interface 620 (preferably another JavaScript program) sends the request to server computer 650 via interconnected data communications network 640.

Remote server computer 650 comprises a rules engine 660, preprogrammed results processor 670, and database communications interface 680. Rules engine 660, which may be programmed using any suitable programming language (although JAVA may be preferred), receives the request transmitted from client device 605 and correlates the responses in the request to partial scores according to a scoring matrix that is preferably stored and/or coded into rules engine 660. Rules engine 660 also sums the partial scores to produce an actual total score. Preprogrammed results processor 670 then interprets the actual total score by comparing the actual total score to an incremented scale of potential total scores (also preferably stored and/or coded into rules engine 660) to determine whether the patient's actual total score, when compared with the ranges of potential total scores in the incremented scale, indicates a low risk, medium risk or high risk of non-adherence.

If the system is configured to generate a message concerning the risk of non-adherence, then database communications interface 680, operating under the control of preprogrammed results processor 670, typically performs the task of actually accessing the message database 685 to retrieve the appropriate message. After retrieving the message, preprogrammed results processor 670 transmits the message (i.e., the risk assessment) back to client device 605 via interconnected data communications network 640.

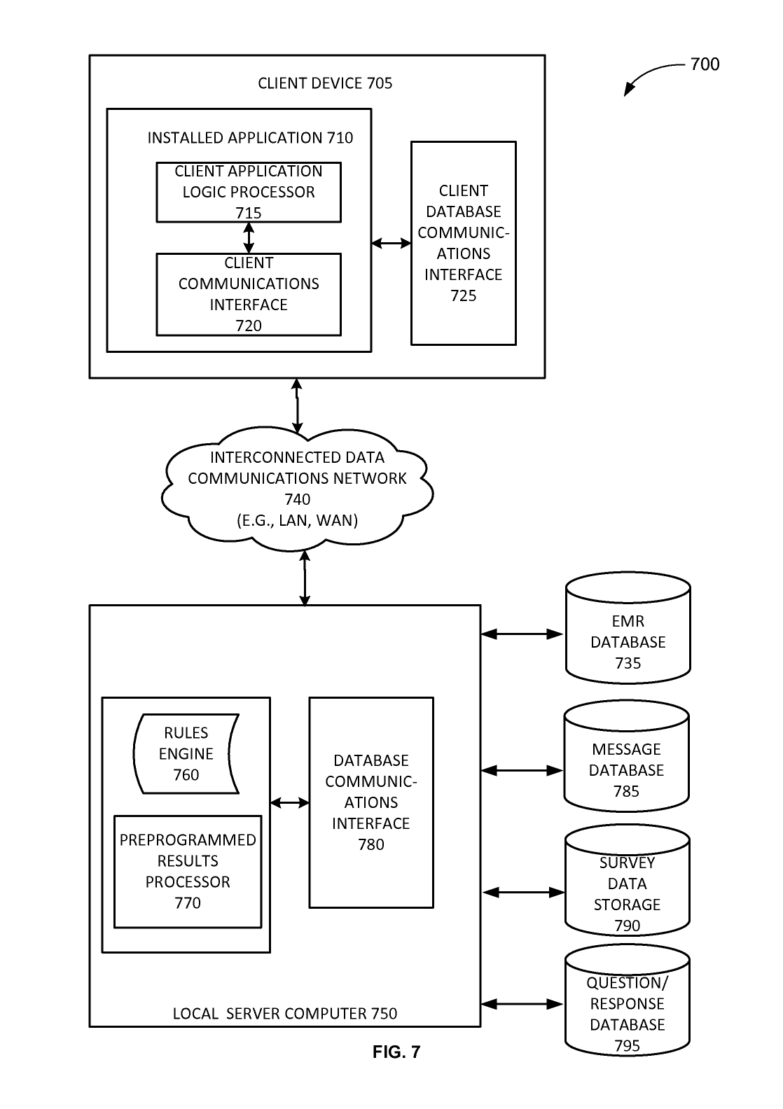

The risk assessment for the patient is produced according to the rules defined by the rules engine 660, which is programmed in preferred embodiments to incorporate and use a scoring matrix like the one shown in FIG. 2. Rules engine 660 may reside within remote server computer 650 (as shown in FIG. 6), on local server computer 750 (as shown in FIG. 7 and discussed below), or elsewhere in the network, depending on the requirements of the particular computing environment.

Question and response database 695 and database communications interface 680 enable the addition, update, or deletion of questions and responses in a question and response library. Survey data storage 690, via database communications interface 680, enables building a survey library of unique surveys by way of adding, updating, and/or deleting questions from question and response database 695 on individual surveys.

Although FIG. 6 illustrates an embodiment of the invention wherein an application service provider (ASP) environment is reflected, it will be appreciated by those skilled in the art that embodiments of the invention may be implemented using alternative network configurations, such as a client-server environment as illustrated in FIG. 7.

FIG. 7 shows a block diagram of an exemplary hardware and software environment consistent with an additional embodiment of the invention. As shown in FIG. 7, client device 705 is coupled to interconnected data communications network 740, which is in turn coupled to local server computer 750. Local server computer 750 is also coupled to databases 735, 785, 790 and 795, which typically store a multiplicity of related data records. Interconnected data communications network 740 may comprise, for example, a local area network, a wide area network, a corporate intranet, and/or corporate firewall. This network structure represents a client-server model.

Client device 705 usually comprises one of a variety of different types of wireless or hard-wired networked computing devices, including for example, but not limited to, desktop or laptop computers, mini-computers, mainframes, handheld computers, personal digital assistants, mobile cell phones, mobile smart-phones, tablet PCs having interactive display screens. Client device 705 is linked to interconnected data communications network 740 via one or more categories of conventional wired or wireless network communications equipment, such as analog, digital subscriber lines (DSL), T1, or cable broadband modems, Ethernet cards and cables, 802.11 wireless cards and routers, and Bluetooth® wireless adaptor cards and links, VPN, and the like.

Client device 705 includes an installed application 710 (an executable), client application logic processor 715 and client communications interface 720. Preferably, installed application 710 is programmed in C, C+S, or JAVA and configured to execute within Microsoft Windows, Apple Macintosh and iPhone OS, and UNIX environments.

In this case, installed application 710 is programmed to display a user interface screen containing a plurality of survey questions and response input fields on a display device (not shown in FIG. 7) connected to client device 705. Preferably, each of the survey questions has six possible responses of which one and only one response is permitted. One example of a suitable user interface screen, containing the plurality of input fields, is discussed above with reference to FIG. 5.

Client application logic processor 720 is a program, application module or applet, which executes within installed application 710, and which makes it possible for the end user to interact with the user interface screen presented by installed application 710. Client application logic processor 715 monitors the user interface screen and captures data entered into the plurality of response input fields by the end user. Based on the captured data, client application logic processor 715 generates a request to store, score, and interpret the values entered into the plurality of input fields by the end user.

Local server computer 750 comprises a rules engine 760, preprogrammed results processor 770, and database communications interface 780. Rules engine 760, which may be programmed using any suitable programming language (although JAVA may be preferred), receives the request and the responses transmitted from client device 705, correlates the responses with partial scores, and produces an actual total score for the responses. Rules engine 760 then sends the actual total score to the preprogrammed results processor 770 to produce a result (i.e., an risk group determination) that will be eventually displayed by client application logic processor 715 on the user interface screen presented by installed application 710. Preprogrammed results processor 770 also stores the risk determination to EMR database 735 via database communications interface 780. The risk assessment is produced by comparing the actual total score to a computer-readable version of an incremented scale of potential total scores, similar to the one shown in FIG. 2, which may be stored in rules engine 760 or some other data storage area in the network.

If the system is configured to produce a message indicating which risk group the patient falls into, then database communications interface 780, operating under control of preprogrammed results processor 770, typically performs the task of actually accessing message database 785 to retrieve the appropriate message. After retrieving the message, preprogrammed results processor 770 transmits the result and the message back to client device 705 via interconnected data communications network 740.

Question and response database 795 and database communications interface 780 enable the addition, update, or deletion of questions and responses to a question and response library. Survey data storage 790, via database communications interface 780, enables building a survey library of unique surveys by way of adding, updating, and/or deleting questions from question and response database 795 on individual surveys.

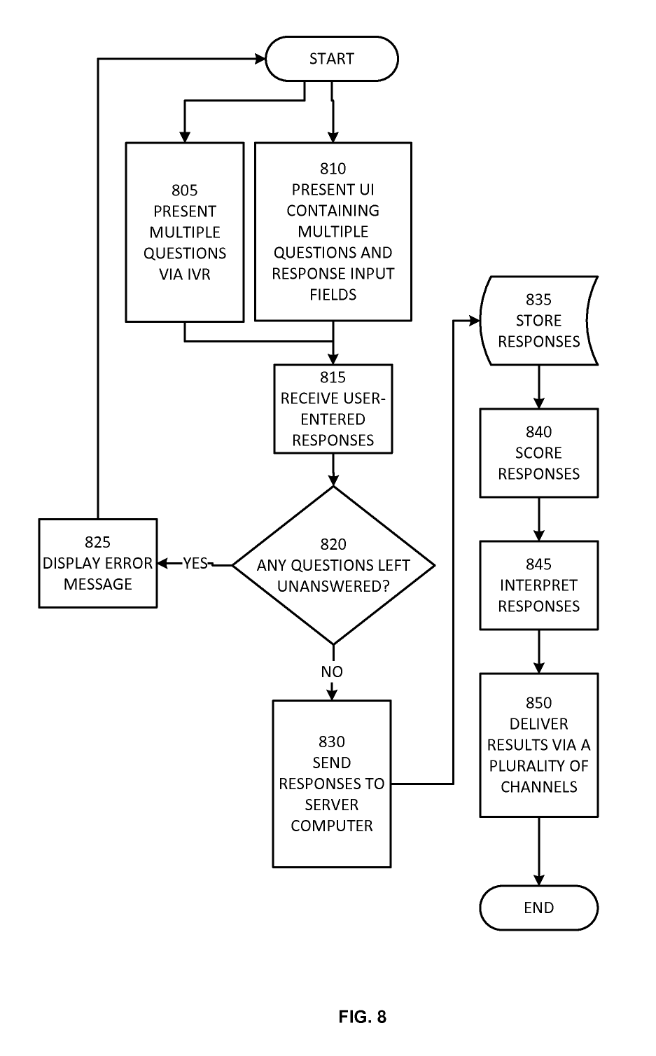

FIG. 8 depicts a program flow chart illustrating the steps that may be performed by client and server computer systems, such as client device 605 and remote server computer 650 depicted in FIG. 6, configured to operate according to embodiments of the present invention. First, at steps 805 and 810, the system presents the user with a user interface comprising a plurality of response input fields. Note, step 810 provides for data input by data entry systems (from direct mail business reply cards), online web page (user initiated and via phone rep) and step 805 takes into account data input via interactive voice recording system (IVR). At step 815, the system receives the input physically entered by the user in response to the survey questions.

A client application logic processor validates whether any of the survey questions have been left answered (step 820). If so, an error message is displayed prompting the user to complete the survey in its entirety (step 825). When the system confirms that the user has entered a response to all of the survey questions, the responses are sent to the server computer (step 830). There, the responses are stored in a database (step 835) and then sent to the preprogrammed results processor to be scored (step 840) and interpreted (step 845) in accordance with the scoring matrix, incremented scale and patient classification system embodied in the rules engine. In step 850, the interpretation a unique result (message) is generated and sent by the results processor to the client device, where it may be displayed on the client device user interface screen and/or delivered to interested parties via a plurality of channels.

It may be necessary or desirable, depending on the particular database application, the computing environment, and the extent of the available resources at the remote server level, to carry out some of the error-checking and result processing functions on the end user's local computer system (i.e., the client computer), rather than on the server computer. In some embodiments, some or even all of the error-checking, performance optimization and result processing functions may be shared (or intentionally duplicated) between various components of both the client computer and the server computer. Embodiments of the present invention may be usefully applied in all these situations.

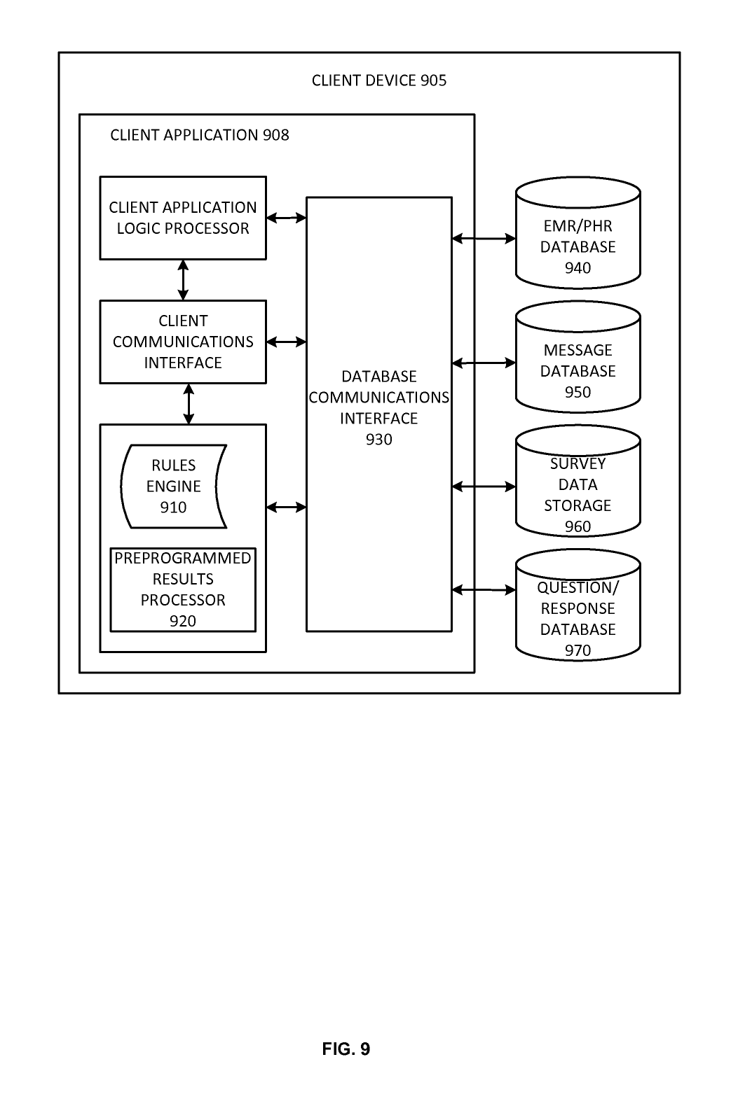

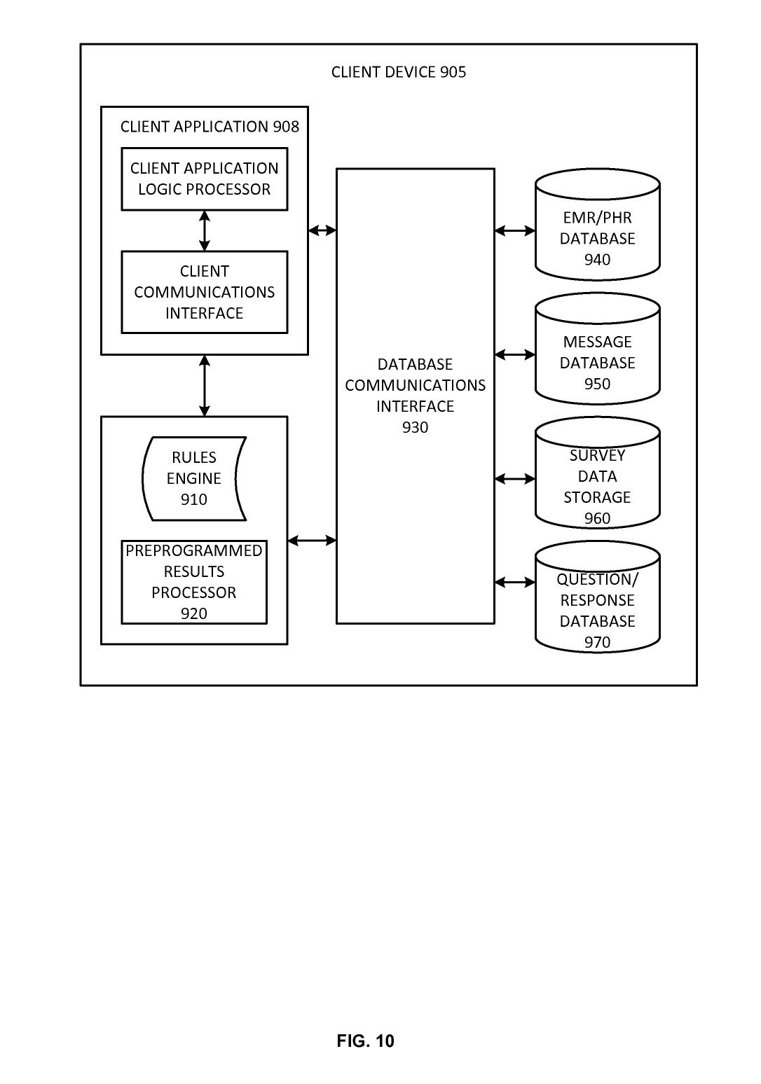

FIGS. 9 and 10 show high-level block diagrams of alternative stand-alone electronic embodiments of the invention, wherein all of the components are associated with a client device 905. Non-limiting examples of the client device 905 may include, for instance, a stand-alone computer system (such as a personal computer, a notebook computer, a laptop computer, a palm computer or netbook), a handheld personal digital assistant (such as a BlackBerry®, Palm Treo®, or Sidekick®), a smart telephone or personal entertainment device (such as an Apple Iphone® or Apple ITouch®), or the like. The client device 905 may also comprise a computer system programmed to respond to voice and keypad inputs entered by the patient over a telephone connection (e.g., an interactive voice response (IVR) unit in a telephone network). The components of the stand-alone computer system embodiment all function substantially the same way they would function in the computer network embodiments shown in FIGS. 6 and 7 and described above. Unlike the computer network embodiments shown in FIGS. 6 and 7, however, in the stand-alone computer system embodiments shown in FIGS. 9 and 10, the rules engine 910, the preprogrammed results processor 920, the database communications interface 930, and the databases 940, 950, 960 and 970, all reside on the client device 905. Because all of the components reside on the client device 905, no connection to a local area network, a wide area network, or the Internet, and no connection to a local or remote server computer, is required. In the stand-alone computer system embodiment shown in FIG. 9, all of the components are embedded with the client application 908. In the embodiment shown in FIG. 10, however, the client application 908 leverages components that are physically external to the client application 908.

The above-described embodiments are intended to illustrate the principles of the invention, but not to limit its scope. Various other embodiments, modifications, and equivalents to these embodiments may occur to those skilled in the art upon reading the present disclosure or practicing the claimed invention. Such variations, modifications, and equivalents are intended to come within the scope of the invention and the appended claims.

### DETAILED DISCUSSION OF THE METHODS USED FOR DETERMINING THE THREE DOMAINS, THE THREE ITEMS, AND THE SCORING MATRIX

A detailed discussion of the methods used for determining the three domains that are the subject of the survey, the three specific items (questions) that are the subject of the prescription survey, as well as the procedure used to create the scoring matrix of the present invention, will now be presented. The Adherence Estimator devices and systems developed from these methods may be implemented in any number of physical forms, including but not limited to, the paper and electronic versions described in detail above.

Qualitative Methods

Thirteen focus groups were conducted with 140 adult consumers in Chicago, Ill. and Atlanta, Ga. to understand reasons for adherence and non-adherence in the 21^{st} century. Adults who were adherent to medications for chronic disease (five groups), as well adults who recently stopped taking their medications without their doctor's advice (eight groups), were recruited. The groups were stratified by gender to eliminate the interaction dynamics that often occur between men and women. Participants were asked to silently write down their reasons for adherence and non-adherence, and were engaged in ranking and rating exercises about their reasons. Open discussions were had about the adherence value proposition, where participants shared the various factors that influenced their decision making about medications. These focus groups were used as discovery methods for a conceptual framework and instrument development.

Quantitative Methods

Two waves (Phase I and Phase II) of psychometric testing of potential items for The Adherence Estimator™ were engaged. The purpose of the Phase I pretest was to ascertain which domains hold the greatest predictive ability for segmenting consumers on their propensity to adhere to prescription medications. The purpose of the Phase II validity fielding was to cross-validate the pretest results in a larger independent sample of adults with chronic disease and to finalize the content of The Adherence Estimator by identifying the specific items with our prioritized domains to be included in The Adherence Estimator™.

Sampling

Both Phase I pretest and Phase II validity sample members were part of the Harris Interactive Chronic Illness Panel (CIP), which is a nationally-representative, internet-based panel of adults with chronic diseases. Harris' CIP is a subsection of the Harris Poll Online Panel (HPOL), which is a multi-million panel of adults who have registered and agreed to participate in online research. Established in 1997, HPOL panelists are recruited through multiple sources, including telephone and mail recruitment, advertisements, and targeted e-mails. The HPOL continuously recruits members to replace panel drop-outs and to maintain national representation across sociodemographic subgroups. During enrollment, respondents provide demographic characteristics and are screened for chronic disease. The Harris CIP is composed of hundreds of thousands of members with chronic disease. Both the Phase I pretest and Phase II validity surveys were conducted using Harris' web-assisted survey software, which uses question rotation and other advanced design features to ensure high data quality.

Randomly-selected members of Harris' CIP were sent an e-mail invitation to participate in our surveys. Panel members were eligible for participation if they were aged 40 and older, resided in the U.S. and screened positive for one of six chronic diseases prevalent among U.S. adults: hypertension, hyperlipidemia, diabetes, asthma, osteoporosis, and other cardiovascular disease. Qualified panel members were instructed to read the informed consent form, click on yes if they agreed to participate, and complete the survey. Qualified panel members could only complete the survey a single time. The protocol for both surveys was approved by the Essex IRB.

Three groups of respondents for both surveys were sampled: self-reported adherers, self-reported non-adherers, and self-reported non-fulfillers to prescription medications. These groups were selected in order to test the ability and efficiently of the scales and items to discriminate between groups of consumers known to differ in their adherence behavior (i.e., known-groups discriminant validity).

During the screening portion of the survey, panel members' chronic disease statuses were re-confirmed. We solicited the number of medications respondents currently took for each disease as well as the length of time they reported taking each medication. These items were used to classify respondents as currently adherent to their medication. To identify respondents as non-adherent, we asked if they had stopped taking a prescription medication for one of the six conditions without their providers telling them to do so in the past year. If respondents answered yes, they were presented with a list of 12 reasons why consumers might stop taking their medications and asked them to choose all that applied to them. To identify respondents as non-fulfillers, we asked if they had received a new prescription for one of the six conditions from their providers but did not fill it in the past year. If respondents endorsed yes, they were presented with a list of 10 reasons why consumers might not fill a new prescription medication and asked them to choose all that applied to them.

A sample size of at least 500 respondents was desired in order to conduct our pretest psychometric analyses with sufficient power and precision. Specifically, principal components analysis optimally requires ten times as many subjects as items, and a two-parameter graded-response item response theory (IRT) model requires at least 500 subjects. Further, because few data are available in the literature on non-fulfillment, we desired a sufficient number of non-fulfillers to assess their differences with non-adherers. A sampling quota for the pretest was set to obtain: (1) a 2:1 ratio of adherers to non-adherers; (2) a 2:1 ratio of non-adherers to non-fulfillers; and (3) a roughly equal number of persons in each chronic disease category for each adherence group. For the pretest, subjects were recruited for only one adherent behavior for a single condition. Once a given quota was met, recruitment was closed to all future potential respondents.

For the Phase II study, a sample size of at least 1,200 respondents was desired in order to conduct the analyses with sufficient power and precision. Further, because very few data are available on the beliefs of persons who are adherent to one medication while non-adherent or non-fulfilling to another, persons who reported different adherent behaviors for different diseases were sampled. A quota was set to obtain a modest sample who were: (1) adherent to one medication for one disease and non-adherent to one medication for a second, different disease; (2) adherent to one medication for one disease and non-fulfilling to one medication for a second, different disease; and (3) non-adherent to one medication for one disease and non-fulfilling to one medication for a second, different disease. We obtained a roughly 1:1 ratio of adherers to non-adherers and a roughly 2:1 ratio of non-adherers to non-fulfillers. Once a given quota was met, Phase II recruitment was closed to all further potential respondents.

Respondents were randomly sampled from the Harris Chronic Disease Specialty panel. For the pretest, requests for survey participation were sent to 39,191 panel members in November of 2007. Of these invitations, there were 3,577 invalid e-mail addresses (e-mail bounce backs). Of the 35,614 invitations with valid e-mail addresses, 11,836 persons entered the survey (33.2% contact rate). Of those successfully contacted, 9,689 (82%) met our study qualification criteria, and 700 persons completed the survey. The 8,989 qualified persons who did not complete the pretest did not do so because our quotas were already met. For the Phase II survey, requests for survey participation were sent to 165,487 panel members in the Spring of 2008. Of these invitations, there were 15,035 with invalid e-mail addresses. Of the 150,452 invitations with valid e-mail addresses, 39,874 persons entered the survey (26.5% contact rate). Of those successfully contacted, 20,299 (51%) met our study qualification criteria, and 1,523 persons completed the survey. The 18,776 qualified persons who did not complete the Phase II survey did not do so because our quotas were already met.

Of the 1,523 respondents to the Phase 2 survey, 1,072 were sampled for a single adherent behavior while 451 were sampled for more than one adherent behavior (e.g., adherent to one medication for one disease and non-adherent to a second medication for a different disease). These latter sample members were not used in the analyses reported herein because we desired to maintain symmetry with our Phase I pretest sampling design and because we did not want to confound our analyses with lack of statistical independence.

Survey Content

Phase I Pretest Survey

Based on the conceptual framework, a comprehensive review of theoretical and empirical work in adherence, and our 13 focus groups, 120 questionnaire items were developed to tap the three hypothesized proximal adherence drivers as well as selected intermediate determinants. A small number of items were derived or adapted from existing, non-copyrighted and non-trademarked surveys. A majority of items were written de novo, in many instances using verbatim language from the focus-group transcripts. Items were written and/or adapted to achieve the following criteria: (1) one attribution (idea) per item; (2) no more than twelve words in length; (3) free of age, gender, and social class biases; and (4) free of double or implicit negatives.

The 44 proximal items measured perceived concerns about prescription medications (k=13), perceived need for prescription medications (k=28), and perceived affordability of prescription medications (k=3). Respondents were directed to answer these questions specific to the adherence group for which they were sampled. For example, if a respondent was sampled as a non-fulfiller, they were instructed to answer the proximal items specific to the medicine they reported not filling. We measured five intermediate domains of adherence drivers using 76 items: patient knowledge of their condition and treatment (k=16); perceived proneness to side effects (k=4); health information-seeking tendencies (k=16); patient trust in their primary provider (k=14); and patient participation in their care (k=26). All items had six possible response categories: 1=agree completely, 2=agree mostly, 3=agree somewhat, 4=disagree somewhat, 5=disagree mostly, and 6=disagree completely. We wrote a large bolus of items because some items will inevitably not perform well psychometrically, and we desired a large reserve of robust items from which to select the best-performing items.

Phase II Survey

We retained 58 of the 120 items from the pretest and developed 12 new items. Because we only fielded three items assessing perceived medication affordability in the pretest, and because of its observed predictive ability, we wrote five additional affordability items for inclusion in the Phase II survey. We also wrote de novo five items assessing the perceived value consumers place on prescription medications vs. vitamins, minerals, and supplements. We added this new domain to test whether the adherence value proposition involved medication affordability per se vs. the perceived value of prescription medications.

We also included in the Phase II survey well-validated, multi-item scales to serve as additional intermediate adherence drivers as well as external validity criteria, including psychological distress, social support, self-efficacy, and internal health locus of control. The inclusion of these constructs is supported by meta-analyses and narrative literature syntheses. We measured psychological distress using the MHI-5, social support using a short-form of the MOS Social Support Scale, self-efficacy using the Generalized self-Efficacy Scale, and internal health locus of control using Wallston's measure. (See Ware J E, Sherbourne C D. “The MOS 36-item Short-Form Health Survey (SF-36): I. Conceptual Framework And Item Selection,” Med Care 1992; 30:473-483; Sherbourne C D, Stewart A L. “The MOS Social Support Survey,” Soc. Sci Med 1991; 32:705-714; Jerusalem, M. and Schwarzer, R. “The Generalized Self-Efficacy Scale” 2008; and Wallston, K A. “Multidimensional Health Locus of Control,” 2008).

Survey Non-Contact Analyses

We used logistic regression to assess differences between selected CIP panel members with valid e-mail addresses who did and did not responded to the survey invitation. Independent variables were age, gender, race, education, and income.

Psychometric Analysis

Unidimensionality Assessment, Multi-Item Scaling, and Internal-Consistency Reliability

To understand the internal structure of the items (i.e., unidimensionality or the extent to which items measure just one thing in common), we compared the ratio of the first to second eigenvalue using a principal components analysis. A 2:1 or better ratio is supportive of scale unidimensionality. Each multi-item scale was computed using Likert's method of summated ratings in which each item is equally weighted and raw item scores are summed into a scale score. (See Liked R. “A Technique For The Measurement Of Attitudes,” Arch Psychol 1932; 140:5-55). All scale scores were linearly transformed to a 0-100 metric, with 100 representing the most favorable state (or attitude), 0 the least favorable, and scores in between representing the percentage of the total possible score. We computed Cronbach's alpha coefficient to estimate the internal-consistency reliability.

Known-Groups Discriminant Validity

The primary purpose of the Phase I pretest was to assess known-groups discriminant validity at the multi-item scale level, which is the extent to which scales discriminate between mutually-exclusive groups known to differ a priori on the construct of interest. Our known-groups were defined by self-reported adherence status: self-reported adherers, self-reported non-adherers, and self-reported non-fulfillers. We used general linear models and t-tests to assess discriminant validity. We hypothesized that, compared to non-adherers and non-fulfillers, adherers would show the most favorable beliefs vis á vis perceived need for medications, perceived concerns about medications, perceived medication affordability. We also hypothesized that adherers would express the least proneness to side effects, the most knowledge about their disease and treatment, and the most favorable perceptions about health information-seeking, trust in their provider, and participation in their care. We did not have an a priori hypothesis about any differences in beliefs between non-adherers and non-fulfillers.

For the Phase 2 analyses, we repeated scale-level tests of known-groups discriminant validity as well as assessed known-groups discriminant validity at the item level, which is the extent to which individual items discriminate between mutually-exclusive groups known to differ a priori on the construct of interest. Our known-groups were exactly the same for those used for scale-level tests: self-reported adherers, non-adherers, and non-fulfillers. The item-level tests were intended to identify which specific items were among those most discriminating. Such information would be used in conjunction with other psychometric criteria to select the final items for The Adherence Estimator. Item-level tests were conducted using general linear models and were cross-validated using chi-square analyses.

Logistic Regression

We extended the tests of known-groups discriminant validity to a logistic regression model predicting self-reported adherence vs. non-adherence and non-fulfillment combined. The independent variables were the proximal and intermediate multi-item scales. We divided each scale into quartiles and represented each quartile as dummy variables in order to assess scale monotonicity. The highest quartile on each scale (representing the most favorable 25% of the score distribution) was the reference group. We used a forward stepwise logistic regression with entry and retention criteria set at the 0.01 probability level. We repeated the models adding demographic variables as independent variables.

Item Reduction Techniques

We used a variety of techniques to achieve item reduction among the Phase I pretest items as well as select the final items for The Adherence Estimator itself. Item frequency distributions were examined for the range and variability of responses as well as for floor and ceiling effects. We calculated item-total correlations to assess which items contributed the most to their respective scales. We executed a two-parameter, graded-response IRT model from MULTILOG. We prioritized items that were discriminating and whose boundary location estimates were evenly spaced (indicating that each rating point contributed equally to ability). We examined known-groups discriminant validity of the items and prioritized those items which best discriminated among the known adherence groups.

Scoring Matrix for The Adherence Estimator

To derive the final scoring weights for The Adherence Estimator, we repeated the logistic regression using the three selected individual items as independent variables. Each item was represented as dummy variables, with five dummy variables per item given that each item had six categorical responses.

Characterization of Adherence Risk Groups

We characterized the adherence risk groups derived from the scoring matrix in terms of their demographic characteristics as well as the intermediate adherence determinants that were not included in The Adherence Estimator™. Categorical variables were tested using chi-square analyses while interval-level variables were tested with general linear models.

Results

Survey Contact

We achieved a 33.2% contact rate for the Phase I survey and a 26.5% contact rate for the Phase II survey. Compared to those who were invited but did not respond to the pretest, those successfully contacted were more likely to be male, age 65 and older, Caucasian, and college educated (data not shown). Compared to those who were invited but did not respond to the Phase II survey, those successfully contacted were more likely to be age 55 and older, Caucasian, and college educated (data not shown).

Sample Characteristics

As shown in Table 1, respondent age ranged from 40-93 with a mean age of 59. About one third of the samples were age 65 or older. From 60%-65% of the samples were female and 89% were self-identified as Caucasian. Around 40% of both samples reported at least a college education, and just over one half reported an income of less than $50,000. A majority of sample members met eligibility criteria for being self-reported adherers while less than one fifth were self-reported non-fulfillers. We achieved a symmetrical quota across the six diseases for the pretest. For the Phase II study, we achieved slightly more respondents with hypertension and hyperlipidemia than the other conditions.

Unidimensionality and Internal-Consistency Analysis: Phase I Pretest

Appendix Table A presents data on unidimensionality and internal-consistency reliability of the pretest items. Two of the domains (information-seeking and participation) had one item each that did not load highly on the first principal component (<0.30). The analysis was rerun excluding those two items. All of the domains were highly unidimensional. The ratio of the first-to-second eigenvalue ranged from a low of 5.2 to a high of 15.8. Cronbach's alpha coefficient ranged from a low of 0.88 to a high of 0.98. While the 13 medication concerns items met unidimensionality criteria, the rotated factor analysis suggested that two scales could be reliably derived: an eight-item scale assessing perceived safety of prescription medications and a five-item scale assessing perceived concerns about side effects.

Bivariate, Scale-Level Tests of Known-Groups Discriminant Validity: Phase I Pretest

The scales that most powerfully differentiated the three groups were: (1) side-effect concerns; (2) perceived medication affordability; and (3) perceived need for medications. Differences in group means were consistent with our hypothesis: for all scales, self-reported adherers held the most favorable attitude. Examination of pair-wise means found that none of the differences between non-adherers and non-fulfillers were statistically significant. Accordingly, the analysis was re-executed using a t-test, and observed results mirrored those for the general linear model.

Multivariate, Scale-Level Tests of Known-Groups Discriminant Validity: Phase I Pretest

We cross-validated the bivariate, scale-level tests of known-groups discriminant validity using logistic regression (Table 3). Only our three hypothesized proximal scales were predictive of self-reported adherence. None of the intermediate adherence drivers were entered into the model. Side-effect concerns were highly predictive of adherence behavior, and there was a monotonic association between increasing side-effect concerns and increased likelihood of non-adherence. Respondents with the greatest affordability concerns (Q1) and those with modest affordability concerns (Q2) were 3.6 and 2.3 times as likely, respectively, to be non-adherent. Respondents with the least perceived need (Q4) were 1.7 times more likely to be a non-adherer compared to those with the most perceived need.

Bivariate, Item-Level Tests of Know-Groups Discriminant Validity: Phase I Pretest

Appendix Table B presents a gestalt summary of the item-level tests of known-groups discriminant validity tested. Consistent with the scale-level results, the proximal items were the most differentiating items. However, within most domains, there was great variability in item differentiating ability, with some items being highly discriminating (large value of F and chi-square) while others were not at all.

Item Reduction

We reduced the number of perceived need items from 28 to 14 and the number of medication concern items from 13 to 10. We eliminated one medication affordability item. We reduced the number of patient trust items from 14 to seven, participation items from 26 to seven, knowledge items from 16 to nine, side-effect immunity items from four to three, and information-seeking from 16 to five. We retained items in the following priority: (1) performance in item-level known-groups discriminant validity; (2) highest item and category information from the two-parameter IRT model (available upon request); and (3) least skewed item score distributions.

Unidimensionality and Internal-Consistency Analysis: Phase II

As shown in Appendix Table C, all of the Phase II domains were highly unidimensional. The ratio of the first-to-second eigenvalue ranged from a low of 4.3 to a high of 21.7. Cronbach's alpha coefficient ranged from a low of 0.87 to a high of 0.97.

Bivariate, Scale-Level Tests of Known-Groups Discriminant Validity: Phase II Data

Consistent with the Phase I results, the scales that most powerfully differentiated the three groups were side-effect concerns and perceived need for medications (Table 4). For both scales, self-reported adherers had the fewest side-effect concerns and the most perceived need. Several additional scales were also highly differentiating, including perceived medication affordability, patient trust, perceived value of supplements, patient participation, and perceived proneness to side effects. There were no observed differences between self-reported non-adherers and self-reported non-fulfillers on any of the scales. Observed results for the two-group discriminant (t-test) mirrored those for the general linear model.

Multivariate, Scale-Level tests of Known-Groups Discriminant Validity: Phase II Data

We cross-validated the bivariate tests of known-groups discriminant validity using logistic regression (Table 5). Only our three hypothesized proximal scales were once again most predictive of self-reported adherence. None of the intermediate adherence drivers entered into the model. Side-effect concerns were highly predictive of adherence, and there was a monotonic association between increasing side-effect concerns and increased likelihood of non-adherence. Those in the lowest two quartiles of perceived need were 6.3 and 1.9 times, respectively, more likely to be non-adherers than those in Q4. Those with the most perceived affordability concerns (Q1) were 2.3 times more likely to be non-adherers than those with the least affordability concerns (Q4).

Item Selection for The Adherence Estimator™

Across two waves of data analysis, our three hypothesized proximal drivers proved to be the most efficient and powerful at discriminating between groups known to differ in adherence. Once the predictive domains have been identified and cross-validated, it was time to select the single best item from each domain for inclusion in The Adherence Estimator™. We repeated tests of known-groups discriminant validity at the item level. Appendix Table D summarizes the data.

We had to select among seven affordability items. COST8 performed the best in both the three- and two-group discrimination. In individual regressions predicting adherence, COST8 also exhibited the highest Wald statistic. Examination of item frequency distributions showed COST8 to have the most even distribution across the six categorical rating points. Finally, item information curves from the graded-response IRT model indicated COST8 to assess a wider range of the latent construct of affordability than the other six items. For these reasons, COST8 (“I feel financially burdened by my out-of-pocket expenses for my prescription medications”) was selected for inclusion in The Adherence Estimator™.

We had to select among five medication concern items. CONCERN11 and CONCERN13 performed very similarly in item-level tests of known-groups discriminant validity. However, data from the IRT analysis showed the category information curves to be more informative for CONCERN11 than CONCERN13. Additionally, CONCERN11 exhibited a less skewed item distribution than did CONCERN13. For these reasons, CONCERN11 (“I worry that my prescription medication will do more harm than good to me”) was selected for inclusion in The Adherence Estimator™.

We had to select among 15 items assessing perceived need for medications. Five items were top candidates (KNOW16, NEED25, NEED16, NEED15, and NEED12). All of them performed very well in known-group tests of discriminant validity. However, KNOW16 yielded the most item and category information from the graded-response IRT model, and it had the highest item-total correlation, which suggests it was the best single-item measure of the underlying construct. Thus, KNOW16 (“I am convinced of the importance of my prescription medication”) was selected for inclusion in The Adherence Estimator™.

Scoring Matrix and Characterization of the Adherence Risk Groups

Table 6 presents the self-scoring matrix for The Adherence Estimator™. The item category weights were derived from a logistic regression equation with the items represented as dummy variables. The obtained c statistic from the equation was 0.834 and the Hosmer and Lemeshow goodness-of-fit test was 9.22 (p=0.33). We stayed true to the magnitude of the obtained odds ratio except when it was necessary to make slight proportionate amendments in order to have each final score be derived in one and only one possible way. As the table shows, one sums the three numbers to obtain The Adherence Estimator™ score. Because each score can be obtained in one and only one way, they are easily interpretable. For example, there is only one way to obtain a score of seven—a patient scoring seven has a moderate perceived need for medication, but no issues with side-effect concerns of medication affordability. A patient scoring 22 has a very low perceived need for medication as well as medication affordability issues.

We cross-tabulated the score distribution from the total score of The Adherence Estimator™ with self-reported adherence rate and derived a three-group risk classification (low, medium, and high risk of non-adherence). Sensitivity was 86%—of the non-adherers, 86% would be accurately classified as medium or high risk by the Adherence Estimator™. The false negative rate was 14%—14% of non-adherers would be classified as low risk. Specificity was 59%. Of the adherers, 59% would be classified as low risk by The Adherence Estimator™. The false positive rate was 41%—these are adherent patients who would be falsely classified as medium or high risk.

Table 7 presents a characterization of the three risk groups by demographic characteristics and the intermediate adherence drivers. The low risk group was characterized by the oldest mean age and the largest percentage with persons age 65 and older. The low risk group was under-represented by females relative to the medium- and high-risk group. There were no differences across the groups in race. The medium- and high-risk groups had the highest percentage with income less than $35,000 annually (39% and 30%, respectively. These same two groups also had the lowest percentage of college graduates (34% and 35% each).

With one exception (health information-seeking), the low-risk group scored the best on all of the intermediate adherence drivers. With one exception (psychological distress), the high-risk group scored the worst on all of the intermediate adherence drivers. The greatest differences between the risk groups were observed in perceived safety of prescription medications (F value=225) and patient knowledge (F value=175). Perceived medication safety was a hypothesized proximal driver that did not have as much predictive power as perceived side-effect concerns. Thus, it is logical that it emerged as the principal differentiating factor among the risk groups. That patient knowledge was the second best differentiator is consistent with the proximal-distal continuum insofar as knowledge is a disease-specific attribute. The weakest observed associations were for the more distal psychosocial states (social support, self-efficacy, and locus of control). For perceived medication safety, perceived value of supplements, and perceived proneness to side effects, there was an equal proportionate difference in scores between the low and medium risk and between the medium and high risk). For knowledge, trust, and participation, the high-risk group scored proportionately lower vis á vis the medium-risk group than the medium-risk group did vis á vis the low-risk group. The opposite was observed for psychological distress and social support: the medium-risk group scored proportionately lower vis á vis the low-risk group than the high-risk group did vis á vis the medium-risk group.

TABLE 1
Sociodemographic Characteristics of Samples

| | Pretest Sample | Phase 2 Sample |
|---|---|---|
| Sociodemographic Characteristic | N = 700 | N = 1,072 |
| Mean age | 59.5 | 58.2 |
| % age 65+ | 35.0% | 30.3% |
| % female | 60.3% | 64.7% |
| % white | 88.8% | 89.4% |
| % African American | 4.4% | 5.4% |
| % Hispanic | 2.6% | 2.9% |
| % other race | 4.2% | 2.3% |
| % <high school | 1.0% | 1.1% |
| % high school graduate | 12.7% | 15.3% |
| % some college but no degree | 33.1% | 42.1% |
| % Associates degree | 11.6% | 8.2% |
| % Bachelor's degree | 24.3% | 16.4% |
| % graduate or professional degree | 17.3% | 16.8% |
| % income <%25K | 20.8% | 15.2% |
| % income $25K-$50K | 31.1% | 36.1% |
| % income $50K-75K | 20.8% | 20.9% |
| % income $75K-$100K | 12.2% | 13.7% |
| % income $100K-$125K | 7.9% | 5.8% |
| % income >$125K | 7.0% | 5.0% |
| % asthma | 17% | 14% |
| % diabetes | 17% | 14% |
| % hyperlipidemia | 18% | 23% |
| % hypertension | 17% | 25% |
| % osteoporosis | 16% | 16% |
| % other cardiovascular disease | 15% | 7% |
| % adherer | 58% | 41% |
| % non-adherer | 27% | 40% |
| % non-fulfiller | 15% | 19% |

TABLE 2
Summary of Bivariate, Scale-Level Known-Groups Discriminant Validity: Phase
I Pretest Sample (n = 700)

| | | | | F test: Three- | | T-test: | |
|---|---|---|---|---|---|---|---|
| | | Mean for | Mean | Group | | Two-Group | |
| | Mean for | Non- | for Non- | Discrimination² | | Discrimination³ | |
| Multi-Item Scale¹ | Adherers | Adherers | Fulfillers | F | P value | T | P value |
| Hypothesized Proximal | | | | | | | |
| Drivers | | | | | | | |
| Perceived medication | | | | | | | |
| concerns | | | | | | | |
| Side-effect concerns | 82.5 | 64.7 | 62.0 | 56.5 | <.0001 | 10.1 | <.0001 |
| Safety concerns | 63.3 | 50.4 | 55.0 | 20.7 | <.0001 | 6.2 | <.0001 |
| Perceived need for | 73.8 | 64.9 | 63.1 | 24.5 | <.0001 | 6.5 | <.0001 |
| medications | | | | | | | |
| Perceived medication | 51.4 | 32.5 | 28.9 | 38.1 | <.0001 | 8.7 | <.0001 |
| affordability | | | | | | | |
| Hypothesized | | | | | | | |
| Intermediate Drivers | | | | | | | |
| Knowledge | 79.3 | 75.6 | 77.1 | 3.4 | .033 | 2.5 | .012 |
| Perceived proneness to | 61.7 | 54.9 | 53.7 | 6.2 | .002 | 3.5 | .0005 |
| side effects | | | | | | | |
| Patient trust | 79.2 | 71.5 | 70.7 | 12.8 | <.0001 | 4.8 | <.0001 |
| Patient participation | 76.4 | 69.2 | 68.8 | 10.5 | <.0001 | 4.4 | <.0001 |
| Health information- | 75.8 | 74.9 | 74.2 | 0.5 | .624 | 0.9 | .373 |
| seeking | | | | | | | |

¹Higher scores represent more favorable beliefs: fewer side-effect concerns, fewer safety concerns, better perceived need for medications, better perceived medication affordability, more knowledge, less perceived proneness to side effects, more trust, more participation, and more information-seeking.
²Three-group discrimination was self-reported adherers vs. non-adherers vs. non-fulfillers
³Two-group discrimination was self-reported adherers vs. non-adherers and non-fulfillers combined

TABLE 3
Summary of Multivariate, Scale-Level Known-Groups
Discriminant Validity: Pretest Data (n = 700)

| | Adherence vs. Non-Adherence/Non- |
|---|---|
| | Fulfillment Odds Ratio and CI |
| Side-effect concerns (reference = | |
| Q4, least side-effect concerns) | |
| Q3 | 2.75 (1.66-4.55) |
| Q2 | 3.70 (2.17-6.29) |
| Q1 (most side-effect concerns) | 7.77 (4.39-13.77) |
| Perceived need for medications | |
| (reference = Q4, most perceived | |
| need for medications) | |
| Q3 | 0.62 (0.38-1.03) |
| Q2 | 0.79 (0.48-1.31) |
| Q1 (least perceived need) | 1.71 (1.01-2.88) |
| Perceived medication affordability | |
| (reference = Q4, most perceived | |
| affordability) | |
| Q3 | 0.85 (0.52-1.38) |
| Q2 | 2.31 (1.42-3.74) |
| Q1 (least perceived affordability) | 3.61 (2.22-5.88) |

TABLE 4
Summary of Bivariate, Scale-Level Known-Groups Discriminant Validity: Phase
2 (n = 1,072)

| | | | | F test: Three- | | T-test: | |
|---|---|---|---|---|---|---|---|
| | | Mean for | Mean | Group | | Two-Group | |
| | Mean for | Non- | for Non- | Discrimination² | | Discrimination³ | |
| Multi-Item Scale¹ | Adherers | Adherers | Fulfillers | F | P value | T | P value |
| Hypothesized Proximal | | | | | | | |
| Drivers | | | | | | | |
| Perceived medication | | | | | | | |
| concerns | | | | | | | |
| Side-effect concerns | 76.6 | 54.4 | 55.0 | 178.2 | <.0001 | 19.6 | <.0001 |
| Safety concerns | 58.8 | 49.4 | 48.1 | 28.6 | <.0001 | 7.5 | <.0001 |
| Perceived need for | 77.7 | 60.3 | 60.8 | 143.2 | <.0001 | 17.8 | <.0001 |
| medications | | | | | | | |
| Perceived medication | 59.7 | 46.9 | 46.4 | 21.2 | <.0001 | 6.6 | <.0001 |
| affordability | | | | | | | |
| Hypothesized | | | | | | | |
| Intermediate Drivers | | | | | | | |
| Knowledge | 83.4 | 75.5 | 76.4 | 36.8 | <.0001 | 8.8 | <.0001 |
| Perceived proneness to | 62.9 | 50.7 | 48.5 | 35.7 | <.0001 | 8.5 | <.0001 |
| side effect | | | | | | | |
| Patient trust | 78.8 | 64.5 | 64.8 | 58.7 | <.0001 | 11.5 | <.0001 |
| Patient participation | 77.8 | 66.2 | 67.9 | 35.1 | <.0001 | 8.7 | <.0001 |
| Health information- | 76.4 | 75.6 | 76.2 | 0.2 | .802 | 0.5 | .589 |
| seeking | | | | | | | |
| Value of supplements | 28.8 | 43.7 | 45.1 | 50.7 | <.0001 | 10.5 | <.0001 |
| Psychological distress | 74.1 | 66.7 | 67.7 | 16.5 | <.0001 | 6.1 | <.0001 |
| Social support | 69.4 | 60.9 | 63.0 | 8.5 | .0002 | 4.1 | <.0001 |
| Internal locus of control | 66.9 | 63.9 | 66.8 | 3.5 | .031 | 2.1 | .040 |
| Self-efficacy | 73.6 | 71.2 | 70.6 | 3.3 | .037 | 2.6 | .009 |

¹Higher scores represent more favorable beliefs: fewer side-effect concerns, fewer safety concerns, stronger perceived need for medications, better medication affordability, more knowledge, less perceived proneness to side effects, stronger trust, more participation, more information-seeking, higher value on supplements, less psychological distress, more social support, more internal locus of control, better self-efficacy
²Three-group discrimination was self-reported adherers vs. non-adherers vs. non-fulfillers
³Two-group discrimination was self-reported adherers vs. non-adherers and non-fulfillers combined

TABLE 5
Summary of Multivariate, Scale-Level Known-Groups
Discriminant Validity: Phase II Data (n = 1,072)

| | Adherence vs. Non-Adherence/Non- |
|---|---|
| | Fulfillment Odds ratio and CI |
| Side-effect concerns (reference = | |
| Q4, least side-effect concerns) | |
| Q3 | 1.98 (1.42-2.78) |
| Q2 | 4.41 (3.01-6.46) |
| Q1 (most side-effect concerns) | 12.73 (7.76-20.87) |
| Perceived need for medications | |
| (reference = Q4, most perceived | |
| need) | |
| Q3 | 1.19 (0.87-1.64) |
| Q2 | 1.94 (1.39-2.70) |
| Q1 (least perceived need) | 6.27 (4.12-9.55) |
| Perceived medication affordability | |
| (reference = Q4, most perceived | |
| affordability) | |
| Q3 | 0.91 (0.65-1.27) |
| Q2 | 0.97 (0.68-1.38) |
| Q1 (least perceived affordability) | 2.33 (1.65-3.28) |

TABLE 6
Self-Scoring Matrix for The Adherence Estimator ™

| | Agree | Agree | Agree | Disagree | Disagree | Disagree |
|---|---|---|---|---|---|---|
| | Completely | Mostly | Somewhat | Somewhat | Mostly | Completely |
| I am convinced of | 0 | 0 | 7 | 7 | 20 | 20 |
| the importance of | | | | | | |
| my prescription | | | | | | |
| medication | | | | | | |
| I worry that my | 14 | 14 | 4 | 4 | 0 | 0 |
| prescription | | | | | | |
| medication will do | | | | | | |
| more harm than | | | | | | |
| good to me | | | | | | |
| I feel financially | 2 | 2 | 0 | 0 | 0 | 0 |
| burdened by my | | | | | | |
| out-of-pocket | | | | | | |
| expenses for my | | | | | | |
| prescription | | | | | | |
| medication | | | | | | |

Add Up the Total Number of Points from the Checked Boxes

| Score | Interpretation |
|---|---|
| 0 | Low risk for adherence problems (>70% probability of adherence) |
| 1-7 | Medium risk for adherence problems |
| | (35%-69% probability of adherence) |
| 8+ | High risk for adherence problems (<35% probability of adherence) |

TABLE 7
Characterization of the Adherence Risk groups by Demographics
and the Intermediate Adherence Drivers (n = 1,072)

| Risk Groups | Low Risk | Medium Risk | High Risk |
|---|---|---|---|
| Demographic Characteristics | | | |
| Mean Age^{†} | 62 | 58 | 57 |
| Age 65+^{†} | 46% | 28% | 25% |
| Female^{†} | 59% | 66% | 69% |
| Caucasian | 92% | 88% | 89% |
| Income <35K^{†} | 27% | 39% | 30% |
| College educated^{†} | 48% | 34% | 38% |
| Intermediate Adherence | | | |
| Drivers^{1§} | | | |
| Perceived safety of | 70 | 52 | 41 |
| medications | | | |
| Patient knowledge | 87 | 83 | 69 |
| Patient trust in primary care | 80 | 74 | 58 |
| provider | | | |
| Perceived value of | 26 | 34 | 49 |
| supplements | | | |
| Patient participation in their | 80 | 74 | 61 |
| care | | | |
| Perceived proneness to side | 66 | 54 | 44 |
| effects | | | |
| Psychological distress | 76 | 64 | 66 |
| Social support | 71 | 64 | 62 |
| Self-efficacy | 75 | 70 | 70 |
| Health information-seeking | 77 | 78 | 74 |
| tendencies | | | |
| Locus of control | 66 | 64 | 64 |

^{†}Differences between groups statistically significant at p < 0.01
¹Higher scores represent more favorable beliefs: fewer safety concerns, more knowledge, less perceived proneness to sides effects, stronger trust, more participation, more information-seeking, higher value on supplements, less psychological distress, more social support, more internal locus of control, better self-efficacy
^{§}All F statistics are p < .0001 except for health information-seeking tendencies (p = .002) and locus of control (p = .12). Data are ordered by the magnitude of the F statistic.

APPENDIX TABLE A
Summary of Dimensionality and Internal-Consistency
Analyses: Pretest Sample (n = 700)

| | | | Range of | Median | |
|---|---|---|---|---|---|
| | | | loadings with | loading with | |
| | | Ratio of 1^{st} | the first | the first | |
| | | to 2^{nd} | principal | principal | Cronbach's |
| | K | eigenvalue | component | component | alpha |
| Hypothesized Proximal | | | | | |
| Drivers | | | | | |
| Perceived medication | | | | | |
| concerns | | | | | |
| Side-effect concerns | 5 | 6.2 | 0.79-0.85 | 0.83 | 0.88 |
| Safety concerns | 8 | 6.3 | 0.65-0.84 | 0.81 | 0.91 |
| Perceived need for | 28 | 5.2 | 0.32-0.87 | 0.74 | 0.96 |
| medications | | | | | |
| Perceived medication | 3 | 6.0 | 0.84-0.94 | 0.94 | 0.90 |
| affordability | | | | | |
| Hypothesized | | | | | |
| Intermediate Drivers | | | | | |
| Knowledge | 16 | 9.8 | 0.63-0.85 | 0.77 | 0.95 |
| Side-effect susceptibility | 4 | 11.8 | 0.90-0.92 | 0.92 | 0.94 |
| Trust | 14 | 14.5 | 0.76-0.92 | 0.87 | 0.97 |
| Participation | 25 | 15.8 | 0.77-9.93 | 0.86 | 0.98 |
| Information-seeking | 15 | 8.4 | 0.69-0.87 | 0.77 | 0.95 |

APPENDIX TABLE B
Summary of Item-Level Known-Groups
Discriminant Validity (n = 700)

| | | | | Range | Median |
|---|---|---|---|---|---|
| | | Range | Median | of Chi- | Chi- |
| | K | of F | F | Square | Square |
| Hypothesized Proximal | | | | | |
| Drivers | | | | | |
| Perceived medication | | | | | |
| concerns | | | | | |
| Side-effect concerns | 5 | 20.9-49.8 | 34.7 | 51.3-107.3 | 81.9 |
| Medication safety | 8 | 3.6-18.8 | 13.7 | 14.0-46.8 | 35.7 |
| concerns | | | | | |
| Perceived need for | 28 | 1.1-38.0 | 43.5 | 6.3-92.2 | 17.0 |
| medications | | | | | |
| Perceived medication | 3 | 25.4-46.9 | 25.6 | 60.9-103.5 | 61.4 |
| affordability | | | | | |
| Hypothesized | | | | | |
| Intermediate Drivers | | | | | |
| Knowledge | 16 | 0.1-26.6 | 3.7 | 7.8-67.8 | 21.0 |
| Side-effect | 4 | 3.4-7.1 | 5.3 | 18.4-30.2 | 22.8 |
| susceptibility | | | | | |
| Patient trust | 14 | 1.3-19.9 | 10.0 | 8.4-62.7 | 29.5 |
| Patient participation | 25 | 2.6-13.3 | 7.9 | 14.6-42.1 | 26.7 |
| Health information- | 15 | 0.1-2.1 | 0.5 | 7.6-19.2 | 13.5 |
| seeking | | | | | |

APPENDIX TABLE C
Summary of Dimensionality and Internal-Consistency
Analyses: Phase 2 Sample (n = 1,072)

| | | | Range of | Median | |
|---|---|---|---|---|---|
| | | | loadings with | loading with | |
| | | Ratio of 1^{st} | the first | the first | |
| | | to 2^{nd} | principal | principal | Cronbach's |
| | K | eigenvalue | component | component | alpha |
| Hypothesized Proximal | | | | | |
| Drivers | | | | | |
| Perceived medication | | | | | |
| concerns | | | | | |
| Side effect concerns | 5 | 5.5 | 0.74-0.85 | 0.84 | 0.87 |
| Safety concerns | 5 | 4.5 | 0.77-0.86 | 0.82 | 0.87 |
| Perceived need for | 15 | 6.4 | 0.48-0.88 | 0.80 | 0.95 |
| medications | | | | | |
| Perceived medicine | 7 | 21.7 | 0.87-0.96 | 0.93 | 0.97 |
| affordability | | | | | |
| Hypothesized | | | | | |
| Intermediate Drivers | | | | | |
| Knowledge | 9 | 5.6 | 0.69-0.87 | 0.79 | 0.92 |
| Perceived proneness to | 3 | 8.7 | 0.90-0.94 | 0.92 | 0.91 |
| side effects | | | | | |
| Trust | 7 | 17.2 | 0.88-0.93 | 0.92 | 0.97 |
| Participation | 7 | 14.5 | 0.82-0.93 | 0.89 | 0.96 |
| Information-seeking | 5 | 7.9 | 0.79-0.89 | 0.87 | 0.91 |
| Perceived value of | 5 | 16.9 | 0.90-0.93 | 0.92 | 0.95 |
| supplements | | | | | |
| Psychological distress | 5 | 5.1 | 0.70-0.88 | 0.84 | 0.88 |
| Social support | 8 | 8.7 | 0.82-0.90 | 0.88 | 0.96 |
| Internal locus of control | 10 | 4.3 | 0.56-0.82 | 0.76 | 0.90 |
| Generalized self-efficacy | 10 | 7.9 | 0.55-0.82 | 0.81 | 0.92 |

APPENDIX TABLE D
Summary of Item-level Known-Groups Discriminant
Validity: Phase II Data (n = 1,072)

| | F | Chi-square | T | Chi-square | Wald from |
|---|---|---|---|---|---|
| | from Three- | from Three- | from Two- | from Two- | Logistic |
| | Group Test¹ | Group Test¹ | Group Test² | Group Test² | Regression |
| COST8 | 20.2 | 52.5 | 6.6 | 48.2 | 43.9 |
| COST3 | 20.0 | 43.7 | 6.6 | 44.0 | 39.7 |
| COST7 | 19.9 | 46.5 | 6.5 | 42.0 | 38.6 |
| COST4 | 17.6 | 37.6 | 6.2 | 38.7 | 33.9 |
| COST6 | 17.2 | 42.7 | 6.1 | 40.3 | 35.9 |
| COST2 | 16.3 | 37.0 | 5.9 | 35.7 | 32.7 |
| COST9 | 12.1 | 38.6 | 5.1 | 35.6 | 31.1 |
| CONCERN13 | 163.7 | 295.3 | 18.8 | 290.0 | 249.9 |
| CONCERN11 | 133.4 | 248.6 | 16.8 | 243.4 | 219.2 |
| CONCERN5 | 118.9 | 234.0 | 16.1 | 229.5 | 206.6 |
| CONCERN2 | 107.7 | 208.4 | 15.2 | 202.9 | 182.5 |
| CONCERN1 | 52.4 | 122.4 | 10.2 | 99.6 | 95.1 |
| NEED25 | 168.1 | 318.1 | 19.1 | 305.1 | 259.3 |
| NEED16 | 156.1 | 304.2 | 18.8 | 289.5 | 228.7 |
| NEED15 | 149.0 | 282.5 | 18.2 | 301.2 | 214.1 |
| NEED12 | 145.6 | 291.1 | 18.1 | 285.1 | 227.4 |
| KNOW16 | 144.2 | 286.9 | 17.9 | 261.1 | 210.4 |
| NEED11 | 133.7 | 259.1 | 17.3 | 250.4 | 204.2 |
| NEED5 | 96.6 | 202.6 | 14.4 | 188.3 | 171.4 |
| NEED17 | 78.4 | 157.7 | 12.8 | 149.4 | 138.6 |
| CONSEQ2 | 77.2 | 155.4 | 12.8 | 150.3 | 140.4 |
| NEED18 | 75.8 | 167.8 | 12.8 | 157.8 | 139.6 |
| NEED26 | 74.5 | 149.2 | 12.7 | 139.4 | 120.6 |
| NEED7 | 66.4 | 145.9 | 11.9 | 131.4 | 121.4 |
| NEED21 | 46.3 | 108.4 | 9.7 | 99.8 | 95.0 |
| NEED23 | 5.7 | 14.8 | 3.4 | 12.2 | 12.1 |
| CONCERN16 | 2.8 | 23.2 | 2.2 | 10.5 | 10.5 |

¹Three-group discrimination was self-reported adherers vs. non-adherers vs. non-fulfillers;
²Two-group discrimination was self-reported adherers vs. non-adherers and non-fulfillers combined.

What is claimed is:

1. A device for determining a risk group for a patient based on the patient's propensity to adhere to a prescription medication, comprising:
(a) an incremented scale of potential total scores having a first range of potential total scores corresponding to a high risk group, a second range of potential total scores corresponding to a medium risk group, and a third range of potential total scores corresponding to a low risk group;
(b) a prescription survey comprising a plurality of questions to assess the patient's beliefs in respect to no more than three domains, said three domains being (i) the patient's perceived need for the prescription medication, (ii) the patient's perceived safety concerns about the prescription medication, and (iii) the patient's perceived affordability for the prescription medication;
(c) a response recording tool configured to present for each question in said plurality of questions a plurality of potential patient responses, and to record for said plurality of questions a set of actual patient responses given by the patient;
(d) a scoring matrix configured to correlate the plurality of potential patient responses for said each question to a plurality of partial scores, respectively, wherein the plurality of partial scores are selected and arranged in the scoring matrix so that there can be only one set of actual patient responses having correlated partial scores that, when summed together, produces an actual total score equal to a given potential total score on the incremented scale; and
(e) an interpretation tool that indicates the high risk group if the actual total score is equivalent to a potential total score that falls within the first range on the incremented scale, that indicates the medium risk group if the actual total score is equivalent to a potential total score that falls within the second range on the incremented scale, and that indicates the low risk group if the actual total score is equivalent to a potential total score that falls within the third range on the incremented scale.

2. The device of claim 1, wherein said plurality of questions to assess the patient's beliefs in respect to said no more than three domains comprises a single question for each one of said three domains.

3. The device of claim 2, wherein the single question to assess the patient's beliefs in respect to the domain of the patient's perceived need for the prescription medication asks the patient to disclose the extent to which the patient is convinced of the importance of the prescription medication.

4. The device of claim 2, wherein the single question to assess the patient's beliefs in respect to the domain of the patient's perceived safety concerns about the prescription medication asks the patient to disclose the extent to which the patient worries that the prescription medication will do more harm than good.

5. The device of claim 2, wherein the single question to assess the patient's beliefs in respect to the domain of the patient's perceived affordability for the prescription medication asks the patient to disclose the extent to which the patient feels financially burdened by an expense associated with taking the prescription medication.

6. The device of claim 1, wherein said plurality of questions to assess the patient's beliefs in respect to said no more than three domains comprises multiple questions for each one of said no more than three domains.

7. The device of claim 1, wherein the prescription survey comprises a plurality of questions to assess the patient's beliefs in respect to no more than two domains, said two domains being (i) the patient's perceived need for the prescription medication, and (ii) the patient's perceived safety concerns about the prescription medication.

8. The device of claim 1, wherein said plurality of questions comprising the prescription survey is printed on a card or sheet of paper.

9. The device of claim 1, wherein said plurality of potential patient responses comprising the response recording tool is printed on a card or sheet of paper.

10. The device of claim 1, wherein said plurality of questions comprising the prescription survey and said plurality of potential patient responses comprising the response recording tool are printed on a single card or sheet of paper.

11. The device of claim 1, wherein
(a) said scoring matrix comprises a card or sheet of paper having a plurality of windows or voids therethrough; and
(b) said response recording tool comprises a second card or sheet of paper adapted to slide into or behind said scoring matrix, such that said set of actual patient responses on said response recording tool is visible through said windows or voids.

12. The device of claim 11, wherein each one of said plurality of partial scores is printed adjacent to one of said plurality of windows or voids, respectively, on the card or sheet of paper comprising the scoring matrix.

13. The device of claim 1, further comprising:
(a) a client device;
(b) a server;
(c) a rules engine, residing on the server, the rules engine having one or more data structures defining the incremented scale and the scoring matrix;
(d) a client application, operating on the client device, that (i) displays said plurality of questions and said plurality of potential patient responses to an end user via a computer-controlled display associated with the client device, and (ii) receives the set of actual patient responses from the patient;
(e) a client communications interface configured to send the set of actual patient responses to the server; and
(f) a preprogrammed results processor, residing on the server, that automatically assigns the patient to the high risk group, the medium risk group or the low risk group based on the incremented scale and the scoring matrix defined by the rules engine.

14. A computer system for determining a risk group for a patient based on the patient's propensity to adhere to a prescription medication, comprising:
(a) a database comprising a prescription survey having a plurality of questions to assess the patient's beliefs in respect to no more than three domains, said three domains being (i) the patient's perceived need for the prescription medication, (ii) the patient's perceived safety concerns about the prescription medication, and (iii) the patient's perceived affordability for the prescription medication;
(b) a client application configured to present the plurality of questions and a respective plurality of potential patient responses for each one of said plurality of questions, and to receive a set of actual patient responses;
(c) a rules engine comprising one or more data structures defining
(i) an incremented scale of potential total scores having a first range of potential total scores corresponding to a high risk group, a second range of potential total scores corresponding to a medium risk group, and a third range of potential total scores corresponding to a low risk group, and
(ii) a scoring matrix configured to correlate the plurality of potential patient responses for said each question to a plurality of partial scores, respectively, wherein the plurality of partial scores are selected and arranged in the scoring matrix so that there can be only one set of actual patient responses having correlated partial scores that, when summed together, produces an actual total score equal to a given potential total score on the incremented scale; and
(d) a preprogrammed results processor that automatically assigns the patient to the high risk group if the actual total score is equivalent to a potential total score that falls within the first range on the incremented scale, that assigns the patient to the medium risk group if the actual total score is equivalent to a potential total score that falls within the second range on the incremented scale, and that assigns the patient to the low risk group if the actual total score is equivalent to a potential total score that falls within the third range on the incremented scale.

15. The computer system of claim 14, wherein said plurality of questions to assess the patient's beliefs in respect to said no more than three domains comprises a single question for each one of said three domains.

16. The computer system of claim 15, wherein the single question to assess the patient's beliefs in respect to the domain of the patient's perceived need for the prescription medication asks the patient to disclose the extent to which the patient is convinced of the importance of the prescription medication.

17. The computer system of claim 15, wherein the single question to assess the patient's beliefs in respect to the domain of the patient's perceived safety concerns about the prescription medication asks the patient to disclose the extent to which the patient worries that the prescription medication will do more harm than good.

18. The computer system of claim 15, wherein the single question to assess the patient's beliefs in respect to the domain of the patient's perceived affordability for the prescription medication asks the patient to disclose the extent to which the patient feels financially burdened by an expense associated with taking the prescription medication.

19. The computer system of claim 14, wherein said plurality of questions to assess the patient's beliefs in respect to said no more than three domains comprises multiple questions for each one of said no more than three domains.

20. The computer system of claim 14, wherein the prescription survey comprises a plurality of questions to assess the patient's beliefs in respect to no more than two domains, said two domains being (i) the patient's perceived need for the prescription medication, and (ii) the patient's perceived safety concerns about the prescription medication.

21. The computer system of claim 14, wherein the client application comprises a web browser.

22. The computer system of claim 14, further comprising:
(a) a client device;
(b) a server computer; and
(c) a client communications interface;
(d) wherein the client application resides on the client device, the rules engine and the preprogrammed results processor reside on the server computer, and the client communications interface transmits the actual patient responses from the client application on the client device to the preprogrammed results processor on the server computer.

23. In an interconnected computer network comprising a client device, a server, a preprogrammed results processor, a rules engine and at least one data storage area, a method for assigning a patient to a risk group according to the patient's propensity to adhere to a prescription medication, the method comprising:
(a) storing in said at least one data storage area an incremented scale of potential total scores having a first range of potential total scores corresponding to a high risk group, a second range of potential total scores corresponding to a medium risk group, and a third range of potential total scores corresponding to a low risk group;
(b) storing in said at least one data storage area a prescription survey comprising a plurality of questions to assess the patient's beliefs in respect to no more than three domains, said three domains being (i) the patient's perceived need for the prescription medication, (ii) the patient's perceived safety concerns about the prescription medication, and (iii) the patient's perceived affordability for the prescription medication;
(c) preconfiguring the rules engine to define a scoring matrix that correlates a plurality of potential patient responses for said each question to a plurality of partial scores, respectively, wherein the plurality of partial scores are selected and arranged in the scoring matrix so that there can be only one set of actual patient responses having correlated partial scores that, when summed together, produces an actual total score equal to a given potential total score on the incremented scale;
(d) presenting said plurality of questions and said plurality of potential patient responses on the client device;
(e) recording in said at least one data storage area a set of actual patient responses entered into the client device by the patient in response to said plurality of questions;
(f) causing the preprogrammed results processor to automatically produce an actual total score for the patient, in accordance with the rules engine and the scoring matrix, by summing together the partial scores correlated to the set of actual patient responses given by the patient; and
(g) using the preprogrammed results processor to assign the patient to a risk group, wherein the preprogrammed results processor will (i) automatically assign the patient to the high risk group if the actual total score is equivalent to a potential total score within the first range on the incremented scale, (ii) automatically assign the patient to the medium risk group if the actual total score is equivalent to a potential total score within the second range on the incremented scale, and (iii) automatically assign the patient to the low risk group if the actual total score is equivalent to a potential total score within the third range on the incremented scale.

24. The method of claim 23, further comprising displaying the risk group assigned by the preprogrammed results processor on the client device.

25. The method of claim 23, further comprising displaying no more than one question to the patient for each one of said no more than three domains.

26. The method of claim 25, wherein said one question to assess the patient's beliefs in respect to the domain of the patient's perceived need for the prescription medication asks the patient to disclose the extent to which the patient is convinced of the importance of the prescription medication.

27. The method of claim 25, wherein said one question to assess the patient's beliefs in respect to the domain of the patient's perceived safety concerns about the prescription medication asks the patient to disclose the extent to which the patient worries that the prescription medication will do more harm than good.

28. The method of claim 25, wherein said one question to assess the patient's beliefs in respect to the domain of the patient's perceived affordability for the prescription medication asks the patient to disclose the extent to which the patient feels financially burdened by an out-of-pocket expense for the prescription medication.

29. The method of claim 23, further comprising displaying multiple questions on the client device for each one of said no more than three domains.

30. The method of claim 23, wherein the prescription survey comprises a plurality of questions to assess the patient's beliefs in respect to no more than two domains, said two domains being (i) the patient's perceived need for the prescription medication, and (ii) the patient's perceived safety concerns about the prescription medication.
